(19) United States
(12) Patent Application Publication
(10) Pub. No.: US 2023/0279557 A1
(43) Pub. Date: Sep. 7, 2023

(54) SYSTEMS AND METHODS RELATING TO WATER ELECTROLYSIS

(71) Applicant: THE PENN STATE RESEARCH FOUNDATION, University Park, PA (US)

(72) Inventors: Bruce E. LOGAN, State College, PA (US); Le SHI, State College, PA (US)

(21) Appl. No.: 18/005,944

(22) PCT Filed: Jul. 20, 2021
(86) PCT No.: PCT/US2021/042350

§ 371 Date: Jan. 18, 2023

Related U.S. Application Data
(60) Provisional application No. 63/053,918, filed on Jul. 20, 2020.

(51) Int. Cl. C25B 1/04; C25B 9/19; C25B 15/08; C25B 9/65; C25B 9/63

(52) U.S. Cl. CPC C25B 1/04; C25B 9/19; C25B 15/08; C25B 9/65; C25B 9/63

(57) ABSTRACT

According to aspects of the present disclosure, systems and methods are provided for producing hydrogen and oxygen gases by water hydrolysis, which include: a vessel having a first chamber and a second chamber; a membrane permeable to water ions, the membrane separating the first chamber and the second chamber, wherein the membrane is effective to substantially exclude passage of salt ions, and wherein the membrane is optionally permeable to water; an anode in contact with an anolyte in the first chamber; a cathode in contact with a catholyte in the second chamber; and a power source of direct current operably linked to the cathode and the anode; wherein the anolyte comprises a negative ion inert to oxidation and further wherein the catholyte is a saline solution, brackish water, or seawater.

### REFERENCE TO RELATED APPLICATION

This application claims priority to U.S. Provisional Patent Application Ser. No. 63/053,918, filed Jul. 20, 2020, the entire content of which is incorporated herein by reference.

### FIELD OF THE INVENTION

According to general aspects, the present disclosure relates to systems and methods for water hydrolysis. According to general aspects, the present disclosure relates to systems and methods including a vessel having a first chamber and a second chamber, a membrane permeable to water ions, the membrane separating the first chamber and the second chamber, wherein the membrane is effective to substantially exclude passage of salt ions, and wherein the membrane is optionally permeable to water such that said first and second chambers are in fluid connection; an anode in contact with an anolyte in the first chamber; a cathode in contact with a catholyte in the second chamber; and a power source of direct current operably linked to the cathode and the anode; wherein the anolyte comprises a negative ion inert to oxidation and further wherein the catholyte is a saline solution, brackish water, or seawater.

### BACKGROUND OF THE INVENTION

Hydrogen gas accounts for 1% of global energy use, with 50 billion kilograms of gas produced globally each year, about 53% for fertilizer. Hydrogen gas production could increase in the future due to its potential uses in transportation and energy storage. Reducing fossil fuel consumption and CO₂ emissions associated with hydrogen gas production can be accomplished using renewable energy sources, such as solar and wind. However, to make hydrogen gas production by water electrolysis economically competitive to hydrogen gas produced from methane, the costs of the membrane (commonly a cation exchange membrane, “CEM”) and the catalyst layer used in most direct water electrolysis systems must be decreased, as they contribute to nearly half of the cost of the electrolysis cell stack. A second barrier to affordable hydrogen gas production by water electrolysis is the location of the renewable energy. Offshore and coastal sites are especially of interest for hydrogen gas production to link locations with affordable wind or solar arrays with abundant seawater. However, the direct use of seawater as an electrolyte in contact with an anode results in the production of high concentrations of chlorine gas and other toxic chlorinated compounds (e.g. chlorine, chlorine radicals, and other forms of oxidized chlorine) that can damage membranes. Therefore, it is currently necessary to first desalinate water before electrolysis to avoid chloride oxidation. There is a continuing need for new methods of water electrolysis to produce hydrogen gas.

### SUMMARY OF THE INVENTION

According to aspects of the present disclosure, a system for producing hydrogen and oxygen gases by water hydrolysis, is provided which includes: a vessel having a first chamber and a second chamber; a membrane permeable to water ions, the membrane separating the first chamber and the second chamber, wherein the membrane is effective to substantially exclude passage of salt ions, and wherein the membrane is optionally permeable to water such that said first and second chambers are in fluid connection; an anode in contact with an anolyte in the first chamber; a cathode in contact with a catholyte in the second chamber; and a power source of direct current operably linked to the cathode and the anode; wherein the anolyte comprises a negative ion inert to oxidation and further wherein the catholyte is a saline solution, brackish water, or seawater.

According to aspects of the present disclosure, a system for producing hydrogen and oxygen gases by water hydrolysis, is provided which includes: a vessel having a first chamber and a second chamber; a membrane permeable to water ions, the membrane separating the first chamber and the second chamber, wherein the membrane is effective to substantially exclude passage of salt ions, including but not limited to, Na⁺ and Cl⁻, and wherein the membrane is optionally permeable to water such that said first and second chambers are in fluid connection; an anode in contact with an anolyte in the first chamber; a cathode in contact with a catholyte in the second chamber; and a power source of direct current operably linked to the cathode and the anode; wherein the anolyte comprises a negative ion inert to oxidation and further wherein the catholyte is a saline solution, brackish water, or seawater.

The system optionally includes one, two, three, four, or more, conduits for materials to be added or removed from the vessel, such as one, two, three, four, or more conduits for materials to be added or removed from the first chamber and/or one, two, three, four, or more conduits for materials to be added or removed from the second chamber. Materials to be removed include for example, a gas, such as O₂ or H₂, or a liquid, such as an anolyte or catholyte, or a component of either thereof.

According to aspects of the present disclosure, a system for producing hydrogen and oxygen gases by water hydrolysis is provided which includes: a vessel having a first chamber and a second chamber; a membrane permeable to water ions, the membrane separating the first chamber and the second chamber, wherein the membrane is effective to substantially exclude salt ions, and wherein the membrane is optionally permeable to water such that said first and second chambers are in fluid connection; an anode in contact with a anolyte in the first chamber, wherein the anolyte is, or includes, perchlorate; a cathode in contact with an catholyte in the second chamber; and a power source of direct current operably linked to the cathode and the anode; wherein the anolyte comprises a negative ion inert to oxidation and further wherein the catholyte is a saline solution, brackish water, or seawater.

According to aspects of the present disclosure, a system for producing hydrogen and oxygen gases by water hydrolysis is provided which includes: a vessel having a first chamber and a second chamber; a membrane permeable to water ions, the membrane separating the first chamber and the second chamber, wherein the membrane is effective to substantially exclude salt ions, including but not limited to, Na⁺ and Cl⁻, and wherein the membrane is optionally permeable to water such that said first and second chambers are in fluid connection; an anode in contact with a anolyte in the first chamber, wherein the anolyte is, or includes, perchlorate; a cathode in contact with an catholyte in the second chamber; and a power source of direct current operably linked to the cathode and the anode; wherein the anolyte comprises a negative ion inert to oxidation and further wherein the catholyte is a saline solution, brackish water, or seawater.

According to aspects of the present disclosure, the membrane is a reverse osmosis (RO) membrane or a forward osmosis (FO) membrane.

According to aspects of the present disclosure, the membrane resists passage of gases. According to aspects of the present disclosure, the RO membrane resists passage of gases. According to aspects of the present disclosure, the FO membrane resists passage of gases.

According to aspects of the present disclosure, the catholyte is in fluid connection to a source of further catholyte.

According to aspects of the present disclosure, an applied direct current to the power source establishes an electric potential between the cathode and the anode, the membrane allowing for production of hydrogen gas at the cathode and oxygen gas at the anode.

According to aspects of the present disclosure, the anolyte comprises a higher ionic strength than the catholyte, and wherein the membrane allows water molecules to pass from the catholyte to the anolyte to replace water molecules hydrolyzed due to operation of the system.

According to aspects of the present disclosure, the catholyte is a buffered saline solution.

Methods of producing hydrogen gas and oxygen gas by water hydrolysis are provided according to aspects of the present disclosure which include applying a direct current to a system for producing hydrogen and oxygen gases by water hydrolysis, the system including: a vessel having a first chamber and a second chamber; a membrane permeable to water ions, the membrane separating the first chamber 215 and the second chamber, wherein the membrane is effective to substantially exclude Na⁺ and Cl⁻, and wherein the membrane is optionally permeable to water such that said first and second chambers are in fluid connection; an anode in contact with a anolyte in the first chamber; a cathode in contact with an catholyte in the second chamber; and a power source of direct current operably linked to the cathode and the anode; wherein the anolyte comprises a negative ion inert to oxidation and further wherein the catholyte is a saline solution, brackish water, or seawater. According to aspects of the present disclosure, the catholyte is periodically partially or completely refilled. According to aspects of the present disclosure, the anolyte is periodically partially or completely refilled.

### BRIEF DESCRIPTION OF THE DRAWINGS

FIGS. 1A and 1B are graphs showing membrane resistance measured in a four-electrode method with different membranes using 1 M NaCl or NaClO₄ electrolytes (FIG. 1A), or 0.62 M NaCl or NaClO₄ electrolytes (FIG. 1B), 0.06 to 0.6 mA/cm², based on membrane area;

FIGS. 2A and 2B are graphs showing different membranes in a two-electrode system by using two identical 10% Pt/C electrodes as working and counter electrodes using LSV with a scan rate of 5 mV/s (FIG. 2A), and CP with step current density applied (10, 20, 30 and 40 mA cm⁻²) (FIG. 2B), with NaClO₄ (1 M) anolyte and NaCl (1 M) catholyte;

FIGS. 3A, 3B, and 3C are graphs showing LSV measurement for different membranes in a three-electrode system with a 10% Pt/C working electrode, graphite rod counter electrode, and Ag/AgCl reference electrode and with the indicated anolyte and catholyte solution: 3.5% NaCl (0.29 M NaCl) catholyte and 3.5% NaClO₄ (0.62 M) anolyte (FIG. 3A), 1 M NaCl catholyte and 1 M NaClO₄ anolyte (FIG. 3B), and 1 M NaCl catholyte and 1 M NaClO₄ anolyte in 1 M phosphate buffer solution (PBS) (FIG. 3C);

FIGS. 4A, 4B, 4C, and 4D show the concentration of cations and anions in cell using different membranes after applying a constant current of 40 mA cm⁻² between anode and cathode for 1 hour: K+ concentration in anolyte (FIG. 4A) and Na⁺ in catholyte (FIG. 4B), Cl⁻ in anolyte (FIG. 4C) and ClO⁴⁻ in catholyte (FIG. 4D); K⁺ in catholyte, Na⁺ in anolyte, Cl⁻ in catholyte and ClO⁴⁻ in anolyte are presented in FIGS. 13A, 13B, 13C, and 13D;

FIG. 4E is a schematic diagram showing ions moving under constant current, with original solution of KCl (1 M) for catholyte and NaClO₄ (1 M) for anolyte. KCl was used instead of NaCl (as synthetic seawater) for catholyte in order to indicate the cations transport under different conditions;

FIG. 5A is a graph showing proton concentrations in the anolyte for different conditions, assuming a 100% Faradaic efficiency (40 mA cm⁻² for 1 hour): maximum proton concentration for no proton transport through membrane (Max); proton concentrations remaining based on measured ion transport of other salt species (Ion balance) and proton concentrations converted from measured pH values at the end of the experiment (Measured);

FIG. 5B is a graph showing the fraction of charge carried by protons transported through different membranes to sustain the current density of 40 mA cm⁻² or 10 mA cm⁻² for 1 hour (1 M NaClO₄ anolyte and 1 M KCl catholyte).

FIG. 6A is a graph showing volume of generated H₂ and O₂ at a constant current of 40 mA cm⁻² for 1 hour with 1 M NaClO₄ anolyte and 1 M NaCl catholyte;

FIG. 6B includes a graph showing Faradaic efficiency of H₂ and O₂ evolution, and an inset picture showing a lab-made system with cylinders capturing the gases from the anode and cathode filled with colored water to make the water lines more visible (shown for an experiment with the BW/Cat membrane after 1 hour of collection);

FIG. 7 is a diagram showing a system for measuring the membrane resistance with the same salt solution (e.g., 3.5% NaCl) on each side of the membrane, including cathode 20, anode 30, DC power supply 40, multimeter 50, Ag/AgCl 60, salt solution 70 and membrane 80;

FIGS. 8A, 8B, 8C, 8D, 8E, 8F, 8G, and 8H are graphs showing raw data for membrane resistance measurements using the Selmion CEM (Sel), Nafion 117 (Naf), BW, or SW, conducted in NaCl or NaClO₄ (0.62 M or 1 M on either side of the membrane as indicated); each type of membrane was tested with two different pieces for one condition;

FIG. 9 is a graph showing open circuit voltage recorded for 30 seconds before linear sweep voltammetry (5 mV s−1, between 0 V and −1.4 V vs. SHE) measurement for different membranes;

FIGS. 10A, 10B, and 10C are graphs showing corresponding Tafel plots with different membranes under different electrolyte conditions: 0.29 M NaClO₄ anolyte and 0.62 M NaCl catholyte (FIG. 10A), 1 M NaClO₄ anolyte and 1 M NaCl catholyte (FIG. 10B), and 1 M NaClO₄ anolyte and 1 M NaCl catholyte (FIG. 10C) in 1M PBS;

FIG. 11 is a graph showing chronoamperometry (CP) results by applying −1.2 V vs SHE with Selemion CEM in 0.62 M NaCl (3.5%) as synthetic seawater for the catholyte, and 0.62 M NaCl (3.5%) or 0.62 M NaClO₄ for the anolyte; following these tests it was found that the Selemion CEM with a 0.62 M NaCl anolyte was damaged based on visual observations of a change in the color from dark brown to light brown, however, there was no damage using the 0.62 M NaClO₄ anolyte (no color change) due to the absence of chloride ion in solution;

FIG. 12 is a graph showing pH and conductivity summary of each solution before (B=before) and after (A=after) linear sweep voltammetry scans (5 mV s−1, between 0 V and −1.4 V vs. SHE);

FIGS. 13A, 13B, 13C, and 13D are graphs showing the concentration of cations and anions in the indicated anolytes or catholytes using different membranes with an applied current of 40 mA cm⁻² after 1 hour, with 1 M NaClO₄ as anolyte and 1 M KCl as catholyte;

FIGS. 14A, 14B, 14C, 14D, 14E, 14F, 14G, and 14H are graphs showing concentration of cations and anions in the indicated anolytes or catholytes using different membranes without current after 1 hour (control), with 1 M NaClO₄ as anolyte and 1 M KCl as catholyte;

FIGS. 15A, 15B, 15C, 15D, 15E, 15F, 15G, and 15H are graphs showing the concentration of cations and anions in the indicated anolytes or catholytes using different membranes with an applied current of 10 mA cm⁻² after 1 hour, with 1 M NaClO₄ as anolyte and 1 M KCl as catholyte;

FIGS. 16A, 16B, 16C, 16D, 16E, 16F, 16G, 16H, 16I, 16J, 16K, and 16L show inline pH vs time measurement results for each membrane with no applied current, 10 mA cm⁻² and 40 mA cm⁻² for 1 hour with 1 M NaClO₄ as anolyte and 1 M KCl as catholyte;

FIGS. 17A and 17B are two graphs showing pH recorded for final anolyte (FIG. 17A) and catholyte (FIG. 17B) with different membranes after applied current density of 40 mA cm⁻² for 1 hour, with 1 M NaClO₄ as anolyte and 1 M KCl as catholyte, the electrolyte was mixed well after the inline measurement;

FIG. 18A is a graph showing proton concentrations in the anolyte for different conditions, assuming a 100% Faradaic efficiency (40 mA cm⁻² for 1 hour): maximum proton concentration calculated for no proton transport through membrane (Max); proton concentrations remaining based on measured ion transport of other salt species (without diffusion deduction; Ion balance) and assuming ion diffusion not due to passive ion diffusion [with diffusion deduction; Ion balance (diff ded)]; and proton concentrations converted from measured pH values at the end of the experiment (Measured);

FIG. 18B is a graph showing the fraction of charge carried by protons transport through different membranes to sustain 40 mA cm⁻² and 10 mA cm⁻² for 1 hour, with deduction of ions diffusion (1 M NaClO₄ anolyte and 1 M KCl catholyte);

FIG. 19 shows a schematic of a system and method according to the aspects of the present disclosure wherein an RO or FO membrane is disposed in the apparatus to form 2 chambers, whereby only protons or hydroxide ions can pass through the membrane and larger anions and cations are too large to pass through the pores of the membrane; the anolyte electrolyte contains an inert anion, such as perchlorate which is very stable relative to oxidation, and it can be used at high concentrations to draw water from the other chamber to replace water lost to water splitting, where in this example, 105 is an anode, disposed in an anode chamber 115, 125 is a cathode disposed in a cathode chamber 135, 110 is a FO/H+ permeable membrane which separates the anode chamber 115 from the cathode chamber 135, 120 is a draw solution, 130 is seawater at near neutral pH, 140 represents seawater inflow to maintain pH, 145 is an outflow conduit, 150 is ClO⁴⁻ electrolyte (acidic, high salt concentration), and 155 is a power source.

FIGS. 20A, 20B, 20C, and 20D are graphs showing the concentration of cations and anions using BW membrane after applying constant potential of 3.5 V and then 4.0 V (total of 10 cycles, with 1 hour for each cycle): K⁺ concentration in anolyte (FIG. 20A), Na⁺ in catholyte (FIG. 20B), Cl⁻ in anolyte (FIG. 20C), and ClO₄⁻ in the catholyte (FIG. 20D); two pieces of BW membrane were used for duplicate tests; the * shows that the slope of the linear regression was significant at the p<0.05 level; details of the statistical analysis are summarized in Table 1;

FIGS. 21A, 21B, 21C, and 21D are graphs showing the concentration of cations and anions using BW membranes after applying constant potentials of 3.5 V for the first 5 cycles, and then 4.0 V for a total of 10 cycles, with 1 hour for each cycle: Cl⁻ concentration in catholyte (FIG. 21A), K⁺ in catholyte (FIG. 21B), ClO₄⁻ in anolyte (FIG. 21C), and Na⁺ in anolyte (FIG. 21D);

FIG. 21E is a set of graphs showing chronoamperometry (CP) results showing the current in the cells due to applying 3.5 V for the first 5 cycles and 4.0 V for the next 5 cycles; and

FIG. 22 is a schematic diagram showing ion transport through the membrane under applied constant current; hydrated ions are shown in simplified “naked” ion form in this diagram.

### DETAILED DESCRIPTION OF THE INVENTION

The singular terms “a,” “an,” and “the” are not intended to be limiting and include plural referents unless explicitly stated otherwise or the context clearly indicates otherwise.

The present disclosure concerns systems and methods for producing hydrogen gas from a system and method of water hydrolysis.

Systems and methods of water hydrolysis according to aspects of the present disclosure are described herein that use relatively inexpensive commercially available membranes, particularly those developed for reverse osmosis (RO) and forward osmosis (FO), which selectively allow passage of water ions, H⁺ and OH⁻, while substantially prohibiting passage of salt ions, particularly Na⁺ and Cl⁻. In an applied electric field, such membranes allow passage of water ions, protons and hydroxide ions, across the membrane while substantially excluding salt anions and cations from passage across the membrane.

A system and methods according to aspects of the present disclosure includes at least two chambers wherein a first electrode is disposed in a first chamber and a second electrode is disposed in the second chamber, and wherein the first and second electrodes are in electrical communication.

The first chamber contains an anolyte solution with an anode electrode being submerged or partially submerged therein. The second chamber contains a catholyte solution with a cathode electrode submerged or partially submerged therein. The two electrodes are operably connected to an electrical power source. A conductive conduit for electrons may be further featured which is in electrical communication with the anode and the cathode and a power source for enhancing and/or adjusting an electrical potential between the anode and cathode.

According to aspects, a system of the present disclosure includes two chambers that are optionally are in fluid communication, separated by a membrane that selectively allows passage of water ions across the membrane and substantially excludes passage of salt ions, particularly Na⁺ and Cl⁻, across the membrane.

According to aspects, a system of the present disclosure includes two chambers separated by a membrane that selectively allows passage of water ions, but which is not substantially permeable to water, across the membrane and which substantially excludes passage of salt ions, particularly Na⁺ and Cl⁻, across the membrane.

Previous approaches using electrolysis have featured anion or cation exchange membrane, AEM, or CEM (also called a proton exchange membrane, PEM, when the only cations are protons), respectively, to allow for selective ion transport across a membrane. Such membranes, however, allow salt ions, such as Na⁺ through a CEM, and/or Cl⁻ ions to pass through an AEM. However, a membrane included in a system according to aspects of the present disclosure and/or utilized in methods according to aspects of the present disclosure substantially excludes passage of salt ions, such as, but not limited to, Na⁺ and Cl⁻ ions. Thus, according to aspects of the present disclosure and/or methods according to aspects of the present disclosure, an included membrane is not an AEM or CEM.

The phrase “substantially excludes” when used in reference to salt ions refers to exclusion of at least 90% of salt ions, such as, but not limited to, Na⁺ and/or Cl⁻ ions, from passage across the membrane. A membrane included in a system according to aspects of the present disclosure and/or utilized in methods according to aspects of the present disclosure excludes at least 91%, 92%, 93%, 94%, 95%, 96%, 97%, 98%, 99%, or a greater %, of salt ions, including, but not limited to, Na⁺ and/or Cl⁻ ions, from passage across the membrane.

The phrase “substantially excludes” when used in reference to sodium ions (Na⁺) and chloride ions (Cl⁻)” refers to exclusion of at least 90% of Na⁺ and Cl⁻ ions, from passage across the membrane. A membrane included in a system according to aspects of the present disclosure and/or utilized in methods according to aspects of the present disclosure excludes at least 91%, 92%, 93%, 94%, 95%, 96%, 97%, 98%, 99%, or a greater %, of Na⁺ and Cl⁻ ions, from passage across the membrane.

A membrane included in a system according to aspects of the present disclosure and/or utilized in methods according to aspects of the present disclosure provides gas crossover resistance.

Permeability of a membrane to water, water ions, and/or salt ions can be determined by well-established methods, see, for example, Cath et al., Desalination, 312: 31-38, 2013; Mulder, M. Basic Principles of Membrane Technology, Kluwer Academic Publishers, 2001; and Baker, R. W., Membrane Technology and Applications, John Wiley & Sons, 2004.

Briefly, water and/or ion permeability of a porous membrane can be assessed by application of a solution of known concentration of a specified salt for a period of time to one side of the membrane and making appropriate measurements to assess the material that crosses the membrane, e.g. volumetric measurements, and/or conductivity measurements.

For example, the permeability (water flux) and selectivity (rejection) of a membrane can be determined as a function of pressure, e.g. in a range of 1.5-4.1 MPa, using a synthetic brackish water, such as 2000 ppm of NaCl, under dead-end filtration conditions.

A membrane included in a system according to aspects of the present disclosure and/or utilized in methods according to aspects of the present disclosure can be water permeable or water impermeable.

The term “water permeable” refers to a membrane having a water permeability value of at least about 1-2 liters per square meter per hour, L/m²/h (LMH) under a pressure of about 1 bar at 20° C.

RO and FO membranes are well-known in the art and can be obtained commercially. RO and FO membranes include a thin nanoporous film of polymer as an active layer which substantially excludes salt ions. Typically, the active layer is disposed in contact with a thicker, macroporous layer which provides some filtration as well as mechanical support. The thin film active layer is generally in the range of about 0.1 to about 5 microns in thickness. A macroporous layer is typically thicker, such as in the range of 50 microns to less than 10 millimeters, or more, or less as long as the function of the membrane is retained.

RO and FO membranes included in a system according to aspects of the present disclosure and/or utilized in methods according to aspects of the present disclosure include those wherein the thin active layer (also called a selective layer) includes an organic or inorganic polymer or other material, such as, but not limited to, cellulose, polyamide, polymethacrylic acid, polysulfone, ceramics, carbon nanotubes, metal oxides, and polypiperazineamide, that substantially excludes salt ions while optionally permitting water ion passage under a pressure gradient.

A thicker, macroporous structural layer can be any suitable material, such as organic polymer including, but not limited to, polysulfone, cellulose, polyimide, polyamide, polypropylene, polyketone, polyester, and polyethylene terephthalate).

The degree of polymer cross-linking in the active layer and/or structural layer may be adjusted to provide for different desirable permeability and/or structural characteristics.

A membrane included in a system according to aspects of the present disclosure and/or utilized in methods according to aspects of the present disclosure excludes or substantially excludes passage of salt ions, including inorganic and organic salt ions. A membrane included in a system according to aspects of the present disclosure and/or utilized in methods according to aspects of the present disclosure excludes or substantially excludes, without limitation, passage of salt ions, including chlorine, sodium, potassium, and magnesium, ions. The membrane may further exclude or substantially exclude, without limitation, passage of nitrate, sulfate, chlorate and perchlorate ions.

Salt cations excluded from passing through the membrane include, but are not limited to, ammonium NH⁺⁴, calcium Ca²⁺, copper Cu²⁺, iron Fe²⁺, iron Fe³⁺, magnesium Mg²⁺, potassium K⁺, pyridinium C₅H₅NH⁺, quaternary ammonium NR⁺⁴, R being an alkyl group or an aryl group, and sodium Na⁺

Salt anions excluded from passing through the membrane include, but are not limited to, acetate CH₃COO⁻, bicarbonate HCO₃⁻, carbonate CO₃⁻², chloride Cl⁻, chlorate, ClO⁻³, perchlorate, ClO⁻⁴, citrate HOC(COO⁻)(CH₂COO⁻)₂, cyanide C≡N⁻, fluoride F⁻, nitrate NO⁻³, nitrite NO⁻², oxide O⁻², phosphate PO₃⁻⁴, and sulfate SO₂⁻⁴.

A membrane included in a system according to aspects of the present disclosure and/or utilized in methods according to aspects of the present disclosure prevents the anode and cathode chambers from achieving equilibrium.

In some instances, a membrane included in a system according to aspects of the present disclosure and/or utilized in methods according to aspects of the present disclosure exhibits a low area resistance, such as from about 0 to about 100 Ω cm². In some aspects, the membrane may further feature a surface charge modification to provide improved resistance.

A membrane included in a system according to aspects of the present disclosure and/or utilized in methods according to aspects of the present disclosure has a negative surface charge to enhance proton transport.

The orientation of the membrane may further affect resistance. For example, as described below, when the active layer of an RO membrane faced the catholyte that had a higher pH, the overpotential was lower than that obtained with the active layer facing the anolyte which had a lower pH. RO membrane coatings, such as polyethylene glycol, polyvinyl acetate, polydopamine are optionally included to provide a surface charge for the membrane.

Systems for and methods of water electrolysis according to aspects of the present disclosure include asymmetric electrolytes, including a saline solution, brackish water, or seawater catholyte and a salt of an inert anion as an anolyte.

A catholyte included in a system according to aspects of the present disclosure and/or utilized in methods according to aspects of the present disclosure is a salt-containing aqueous solution, such as a saline solution, typically containing greater than 30 to about 50 parts per thousand dissolved salts, seawater, typically containing greater than about 50 parts per thousand dissolved salts, or brackish water, typically containing about 0.5 to about 30 parts per thousand dissolved salts.

In some aspects of the present disclosure, the catholyte is a saline solution or a buffered saline solution. The catholyte may feature sodium chloride and/or potassium chloride in water. The molarity of such salts in the catholyte may be from about 0.1 M to about 5 M. For example, the catholyte may feature sodium chloride and/or potassium chloride at a concentration of about 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2.0, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, 3.0, 3.05, 3.1, 3.15, 3.2, 3.25, 3.3, 3.35, 3.4, 3.45, 3.5, 3.55, 3.6, 3.65, 3.7, 3.75, 3.8, 3.85, 3.9, 3.95, 4.0, 4.05, 4.1, 4.15, 4.2, 4.25, 4.3, 4.35, 4.4, 4.45, 4.5, 4.55, 4.6, 4.65, 4.7, 4.75, 4.8, 4.85, 4.9, 4.95, and 5.0 M.

When a direct current is applied to the system, water molecules are reduced at the cathode to OH⁻ ions and hydrogen gas.

A further feature of the present disclosure is the composition of the anolyte. To avoid unwanted oxidation of chemicals in the anode chamber except for water splitting, the anolyte includes a negative ion inert to oxidation. In some aspects, the anolyte is an aqueous solution containing an inert anion, such as perchlorate anion of a perchlorate salt, sulfate ion of sodium sulfate, or a mixture thereof. According to aspects of the present disclosure, the perchlorate salt is sodium perchlorate.

In further aspects, the anolyte may feature or further feature a nitrate, sulfate or other suitable ion depending on the material composition of the immersed anode and membrane surface chemistry. A feature of the inert anion of the anolyte is that it cannot be further oxidized to other more oxidized compounds for the specific anode chemistry.

When a charge is applied to the system, since the inert anolyte anion cannot be oxidized, water is instead oxidized to H⁺ ions and O₂ gas.

Further, as perchlorate ions and other negative ions inert to oxidation cannot appreciably pass the membrane or be oxidized, they can provide a stable anolyte for the water splitting electrode and may not be appreciably lost into the catholyte chamber.

When using these two different electrolyte solutions, the anolyte may rapidly become acidic, with an increased concentration of protons in the anolyte for transport across the membrane, while the catholyte pH increases with hydrogen gas evolution occurring under relatively alkaline conditions. This approach is fundamentally different from current water electrolysis methods in which both electrolytes are either highly acidic or alkaline. The molarity of such inert negative ions in the anolyte may be from about 0.1 M to about 5 M. For example, the anolyte may feature an inert negative ion such as perchlorate at a concentration of about 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2.0, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, 3.0, 3.05, 3.1, 3.15, 3.2, 3.25, 3.3, 3.35, 3.4, 3.45, 3.5, 3.55, 3.6, 3.65, 3.7, 3.75, 3.8, 3.85, 3.9, 3.95, 4.0, 4.05, 4.1, 4.15, 4.2, 4.25, 4.3, 4.35, 4.4, 4.45, 4.5, 4.55, 4.6, 4.65, 4.7, 4.75, 4.8, 4.85, 4.9, 4.95, and 5.0 M.

In some aspects, the anolyte according to aspects of systems and methods of the present disclosure is an acidic solution. The acidity may be provided by the presence of the inert anion of anolyte, or acid in the anolyte. The pH of the anolyte may increase as water is split to hydrogen ions and oxygen gas. The pH may also decrease due to water flow into the anolyte chamber from the catholyte chamber. The pH of the anolyte may be of about 1.0 to about 6.5. For example, the pH of the anolyte may be of about 1.0, 1.5, 2.0, 2.5, 3.0, 3.5, 4.0, 4.5, 5.0, 5.5, 6.0 or 6.5.

Similarly, the catholyte of the present system and methods of use of such may be at a neutral or basic pH or fluctuations therebetween. The splitting of water at the cathode may raise the pH due to generation of OH″ ions. The pH may further decrease with an outflow of water ions to the anolyte chamber. The pH may further return to neutral by fluid communication with a further source of the catholyte solution, such as additional seawater or brackish water or through periodic replenishment or exchange of the catholyte solution. The pH of the catholyte may be from about 7.0 to about 12.0. For example, the pH may be about 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, or 12.0.

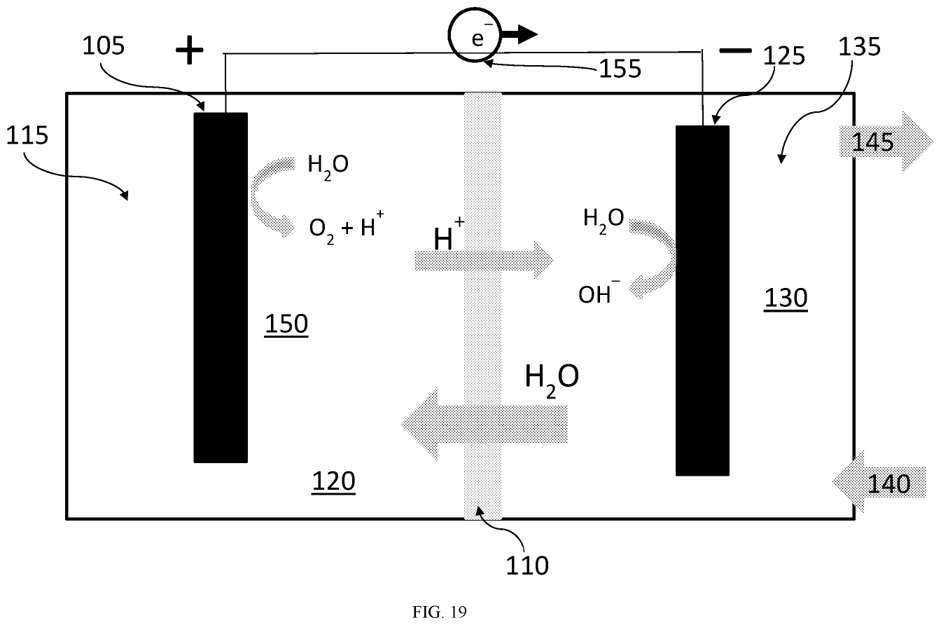

The present disclosure further features seawater or salt water or brackish water as a catholyte solution in the cathode chamber in communication with a further source of additional catholyte solution, such as further seawater or salt water or brackish water (see, e.g. FIG. 19). The catholyte chamber may be separated from the further source by a permeable membrane or may be in fluid communication with the further source, such as with an operable valve and conduit, such as piping. Any membrane connecting the catholyte to the further source would be significantly more permeable such as to allow ion flow and to maintaining a uniform osmotic balance as well as pH level. In other aspects, the catholyte may be periodically replenished or exchanged, partly or completely, with a new solution. Those skilled in the art will appreciate that the system may be set up to receive seawater from an oceanic source. In such instances, the catholyte chamber may be operable to receive or exchange seawater with the source.

Another aspect of the present disclosure is application of a system of the present disclosure to replenish water lost to water splitting with water from seawater, in one of, or both of, the catholyte and the anolyte solutions. As discussed herein, water molecules can be replaced or replenished through exchange or fluid communication with additional catholyte solution. In some other aspects, the ionic concentration in the anolyte is higher than that of the catholyte. In such instances, the imbalanced gradient between the two chambers may pull water molecules into the anolyte chamber by osmotic pressure (see, e.g., FIG. 19). The anolyte may have an ionic concentration of from about 0.011 M to 2 M higher than that of the catholyte. For example, the ionic strength of the anolyte may be about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9 or 2.0 M higher than the catholyte.

In such instances of drawing water molecules to the anolyte, there is no, or a reduced, need to desalinate the seawater prior to application to the system and methods herein. As water molecules may pass through the membrane but the ions in the catholyte, other than H⁺ or OH⁻, cannot readily pass through the membrane, the salinity of the catholyte may be of limited concern as compared to other applications using PEM or CEMs to attempt to split water.

It should also be appreciated by those skilled in the art that an included RO or FO membrane may not be absolutely selective towards passage of ions and molecules other than protons and OH⁻, and are thus described as “substantially” excluding such other ions, as well as gases and molecules. Accordingly, in some instances, it may be expected that very small amounts of sodium or chloride ions may pass through the membrane. In such occurrences, accumulation may be expected to be only very slow, with the anolyte solution possibly requiring infrequent treatment to remove any ions that might prohibit optimum operation. It has been shown in an electro-osmotic test that when water splitting occurs protons will buildup on the surface of the membrane, creating a draw solution for water transfer into the cell (Son et al., Electro-Forward Osmosis. Environ. Sci. Technol. 2019, 53, (14), 8352-8361). In instances where the inert negative ion of the anolyte crosses to the catholyte, treatment can be performed with a biological treatment. Amending the solution with a substrate such as acetate or even dissolved hydrogen can allow the rapid reduction of perchlorate to chloride in several different types of bioreactor systems including packed beds, fluidized beds, and hollow fiber membrane bioreactors.

FIG. 23 is a diagrammatic represent system 200 for producing hydrogen and oxygen gases by water hydrolysis, the system comprising: a vessel 205 having a first chamber 215 and a second chamber 225; a membrane 210 permeable to water ions, the membrane 210 separating the first chamber 215 and the second chamber 225, wherein the membrane 210 is effective to substantially exclude Na⁺ and Cl⁻, and wherein the membrane is optionally permeable to water; an anode 235 in contact with an anolyte 250 in the first chamber 215; a cathode 230 in contact with a catholyte 260 in the second chamber 225; and a power source 270 of direct current operably linked to the cathode 235 and the anode 230; wherein the anolyte 250 comprises a negative ion inert to oxidation and further wherein the catholyte 260 is a saline solution, brackish water, or seawater.

The system 200 optionally includes one, two, three, four, or more, conduits for materials to be added or removed from the vessel 205, such as one, two, three, four, or more conduits 240 for materials to be added or removed from the first chamber 215 and/or one, two, three, four, or more conduits 240 for materials to be added or removed from the second chamber 225. Materials to be removed include for example, a gas, such as O₂ or H₂, or a liquid, such as an anolyte or catholyte, or a component of either thereof.

According to aspects of the present disclosure, a system 200 for producing hydrogen and oxygen gases by water hydrolysis is provided which includes: a vessel 205 having a first chamber 215 and a second chamber 225; a membrane 210 permeable to water ions, the membrane 210 separating the first chamber 215 and the second chamber 225, wherein the membrane 210 is effective to substantially exclude Na⁺ and Cl⁻, and wherein the membrane is optionally permeable to water; an anode 235 in contact with a anolyte 250 in the first chamber 215, wherein the anolyte is, or includes, perchlorate; a cathode 230 in contact with an catholyte 260 in the second chamber 225; and a power source 270 of direct current operably linked to the cathode 235 and the anode 230; wherein the anolyte 250 comprises a negative ion inert to oxidation and further wherein the catholyte 260 is a saline solution, brackish water, or seawater.

In some aspects, an anode and a cathode are provided to the systems and methods disclosed herein, both of which may include an electrically conductive material.

Exemplary conductive materials for an anode may include a carbon paper, a carbon cloth, a carbon wool, a graphite, a conductive polymer, and combinations of the like.

Materials for a cathode may include a carbon cloth, a carbon paper, a carbon wool, a conductive metal, a conductive polymer and combinations thereof.

An included anode material preferably has a low propensity for undesired reactions, such as chloride to chlorine gas. Boron doped diamond is an example of an anode material that has a low propensity for undesired reactions. Additional examples of included materials are those resistant to sulfate or nitrate. RuO₂-based and/or IrO₂ electrodes are included according to aspects of the present disclosure. An included anode material having a low propensity for undesired reactions includes mixed metal oxides, such as TiO₂/IrO₂ and Ir_{0.7}Ta_{0.3}O_{y}/BiₓTi₁₋ₓO_{z}. An included electrode may be an NiFe-layered double hydroxide NiFe-LDH as detailed in Dresp, S. et al., 2018, Adv. Energy Mat. 8(22), 1800338. According to aspects of the present disclosure, an included anode is a boron-doped diamond electrode or is an anode which includes boron-doped diamond electrode.

An electrode may further include a catalyst metal, such as platinum, nickel, tungsten, cobalt, copper, tin, iron, iridium, ruthenium, and palladium, as well as alloys of any two or more thereof. An inexpensive metal can be alloyed or doped with a more expensive metal such as iridium or a precious metal catalyst, to improve activity and/stability.

A platinum catalyst is included according to aspects of the present disclosure. A platinum catalyst is optionally included in the form of Pt/C, Pt nanoparticles (NPs), carbon nanofibers (CNFs), Pt/graphitic nanofibers (GNF), Pt₂Fe, or Pt₂C.

The electrodes may be of various shapes and dimensions, being positioned relative to each other to best facilitate the occurrence of the reactions described herein.

As described herein, oxygen gas may be produced at the anode and hydrogen gas may be produced at the cathode in a system according to aspects of the present disclosure and/or utilized in methods according to aspects of the present disclosure. According to aspects, a gas collection apparatus is included in an inventive system and/or method. Such gas collection apparatus may include a container to collect the gas and/or a conduit for gas passage, such as into attachable containers or to a direct point of use.

Other features may be considered for the systems herein. For example, protective coverings may be applied to one or both electrodes. Such may allow for the conduction of the applied electric potential, without directly exposing the electrodes to the solution. The system may further be enclosed, such as with a lid above each chamber, or a continuous lid over both. In some instances, a lid may be part of a gas collection apparatus or additionally feature an operably valve or outlet to release collected gas.

In some instances, the two chambers are established by disposing a membrane perpendicularly, or nearly perpendicularly to both opposing walls of a single container, thereby portioning the single container into two chambers. It should be appreciated by those skilled in the art that the size of the chambers and the placement of the electrodes with respect to each other are limited only by the power output of the power source. Those skilled in the art will appreciate that the further apart the electrodes are, the greater the resistance the system will experience. Those skilled in the art will appreciate that some determining factors for the placement of the electrodes and the power supplied are controlled by achieving the necessary electric potential for the water molecules to electrolyze to the respective oxygen and hydrogen gases.

In some aspects, a power source is present within the systems and the methods disclosed herein. Such may be present for providing/enhancing/adjusting an electrical potential between the anode and cathode chambers. A power source may include a direct current (DC) power source and an electrochemical cell such as a battery or capacitor. The power source may further feature a means for supplying and disconnecting an electric potential to the system.

The present disclosure provides for a system of splitting water molecules producing oxygen and hydrogen gases. The system features two chambers in fluid connection separated by a membrane or a single chamber portioned into two chambers by a dividing membrane. The membrane may be an RO or an FO membrane. The membrane may be oriented to have an active surface therein face a particular chamber. The membrane may feature an active layer and at least a carrier or support layer affixed thereto.

The two chambers of the system feature solutions for assisting in water splitting. Within each chamber and submerged within partially submerged within the solutions are electrodes that are operably connected to a power source or direct current source, such that one electrode is an anode and the other a cathode, thereby rendering the solutions an anolyte and a catholyte, respectively.

In the system, the catholyte has a neutral or basic pH. The catholyte may be a salty water, such as seawater, brackish water, or other salty water. The catholyte and the chamber containing such, may be connected to a further source of the catholyte solution, such as seawater, brackish water, or other salty water, to allow for replenishing water molecules within the system, such as through operable valves and pipes, or by a further porous membrane.

The system may further feature an inert negative ion in the anolyte, inert being with respect to an inability to be further oxidized. Examples may include perchlorate, nitrates, sulfates, and combinations of two or more thereof.

The system, when operable, applies a direct current to the electrodes, establishing an electrical potential between the two chambers. The membrane properties allow for water ions to pass across, but substantially exclude passage of salt ions. As such, the salt or acid of the anolyte remain in that chamber, as do any salt ions present in the catholyte. The applied electrical potential then allows for water to split at the cathode to hydrogen gas and hydroxide ions, as well as split at the anode to oxygen gas and H⁺ ions. The H⁺ ions may shift to the catholyte.

The system of the present invention may further provide for water movement into the anolyte. For example, providing and/or maintaining a higher osmolarity in the anolyte may draw water molecules across the membrane from the catholyte. The properties of the membrane prevent any other ions present in the catholyte from flowing with the water molecules.

Further features of the system may provide for gas collection and/or gas distribution to a point of use. The system may in some instances be closed or partially closed such as with a lid to contain any produced gas for collection.

Optionally, the system is pressurized. When the system is pressurized, equal pressure, or nearly equal pressure is present on both sides of the membrane such that pressure does not drive movement of ions or water across the membrane.

The present invention also provides methods for producing a hydrogen gas from a water supply. The methods include establishing two separate chambers that are separated by a semipermeable membrane. As discussed herein, the membrane is impermeable to salt ions, but permeable to water ions, and optionally permeable to water. In some instances, the membrane is an RO and/or an FO membrane. The membrane may further feature a surface activation, such as a negative charge. Each chamber is connected with an electrode and filled with a solution to cover or partially cover each electrode. The electrodes may be operably connected to a power source of direct current, to thereby establish one chamber as an anode and anolyte solution and the other as a cathode and a catholyte solution. The anolyte solution may be acidic and feature an acid or a salt thereof that features a negative ion incapable of further oxidation, such as perchlorate. The catholyte may be a neutral or slightly alkaline solution. In some instances, the catholyte is a salt water, such as seawater or brackish water. In further aspects, the anolyte is of a higher osmolarity or solute concentration than the catholyte, such that water molecules are drawn from the catholyte to the anolyte. The methods may further feature applying a direct current to the system to establish an electric potential between the electrodes and across the membrane. Application of the current allows for oxygen gas to form at the anode and hydrogen to form at the cathode. The membrane allows for water ions to pass between the two chambers, but any salt ions of the anolyte and the catholyte, and the negative ion incapable of further oxidation, such as perchlorate, in the anolyte, remain in their respective chambers. Water may further shift to the anolyte in response to an osmotic imbalance across the membrane. In some further aspects, the catholyte is in fluid connection with further sources of the catholyte solution, such that water molecules can be replenished therein, as well as a re-establishing of a more neutral pH in that chamber. In other instances, further catholyte solution is added or exchanged for that present in the arrangement. Oxygen and hydrogen gases produced by application of the required electrical potential may be collected and stored or re-routed to a point of direct use.

Embodiments of inventive compositions and methods are illustrated in the following examples. These examples are provided for illustrative purposes and are not considered limitations on the scope of inventive compositions and methods.

### Examples

The disclosure herein demonstrates a different approach for improving the economic viability of water electrolysis using synthetic seawater based on repurposing low-cost reverse osmosis (RO) membranes to replace expensive CEMs. The cost of the RO membranes (<$10 m⁻²) is an order of magnitude less than those of ion exchange membranes (˜$500-$1000 m⁻²), providing a path for greatly decreasing membrane costs for water electrolyzer systems. In addition, RO membranes can be highly selective for small ions, allowing transport of protons (diameter of 0.20 nm, in the form of H₃O⁺) and OH⁻ ions (0.22 nm) through the membrane (effective pore diameter of ˜0.25 nm) to sustain electrical current generation with an applied potential, while excluding larger competing ions. The RO membrane can further restrict the passage of large salt ions from the anolyte, allowing the use of an anolyte that does not result in the generation of chlorine gas, which damages the membrane. For example, perchlorate is often used as an electrolyte in electrochemical studies because chlorine is fully oxidized and therefore stable, enabling selective water oxidation by the oxygen evolution reaction to produce only O₂. Saline water, such as seawater, can be used as the catholyte without needing to be desalinated as it is kept separated from the anode by the RO membrane. When using these two different electrolytes the anolyte rapidly becomes acidic, increasing the concentration of protons for transport across the membrane, while the catholyte pH increases with hydrogen gas evolution occurring under relatively alkaline conditions. This approach is fundamentally different from current water electrolysis methods in which both electrolytes are either highly acidic or alkaline.

Experiments were performed to compare current densities and potentials needed when using a CEM to those obtained with a RO membrane. The catholyte always contained 3.5% NaCl in this example, while the other solutions are used in the anolyte.

The present examples further compare the performance of two different commercially available RO membranes (BW 30LE and SW 30HR, DuPont) relative to two different commonly used CEMs (Selemion CMV, Asahi Glass; and Nafion 117, Chemours) in terms of membrane resistance at current densities relevant for water electrolyzers. Nafion is commonly referred to as a proton exchange membrane (PEM) when used in electrochemical cells, but it conducts other positively charged cations and therefore it more appropriately referred to as a CEM. Thin film RO membranes include a very thin active layer that selectively restricts large ion transport while permitting water passage under a pressure gradient, and a highly permeable structural layer to support the thin film. The side of the membrane with the active layer usually faces the solution with high salinity to maximize desalination performance. Because of the unique structure of the composite film, this type of membrane can potentially break the trade-off between ionic conductivity and selectivity for a seawater electrolyzer.

RO membranes can have low ionic resistances

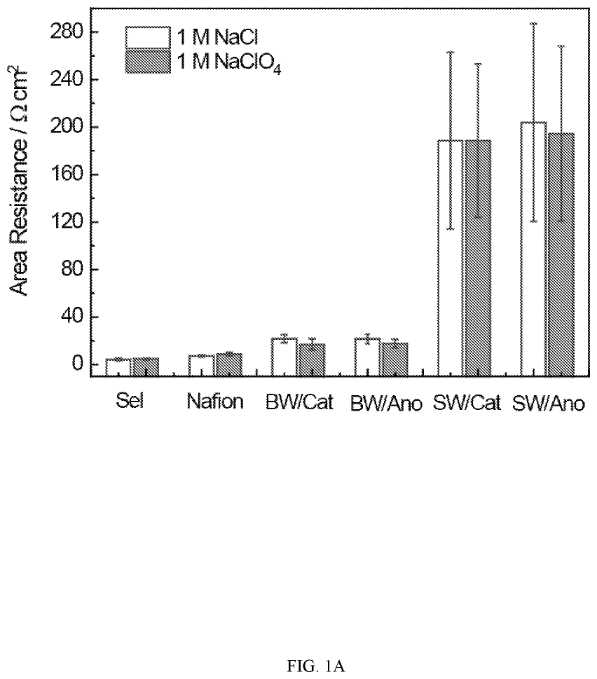

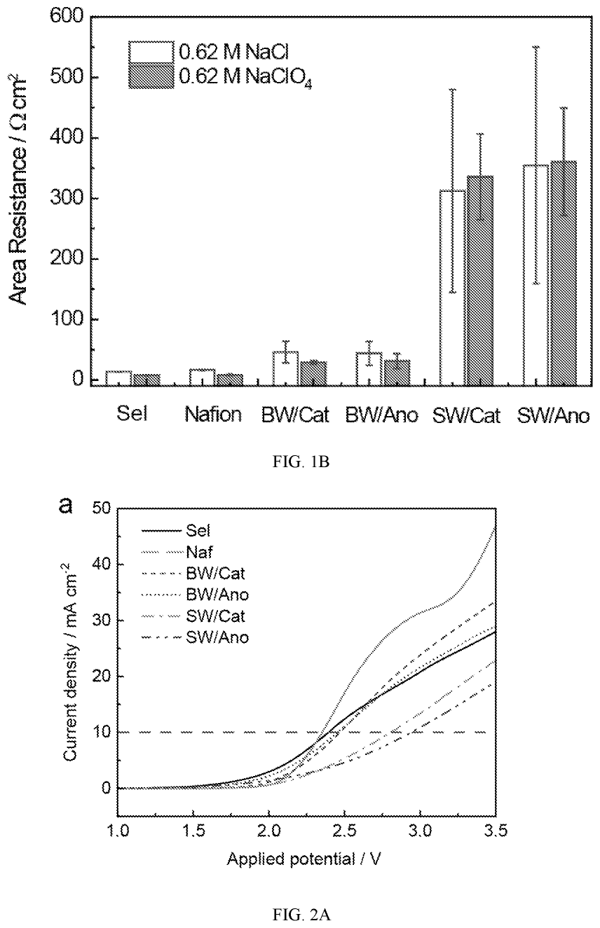

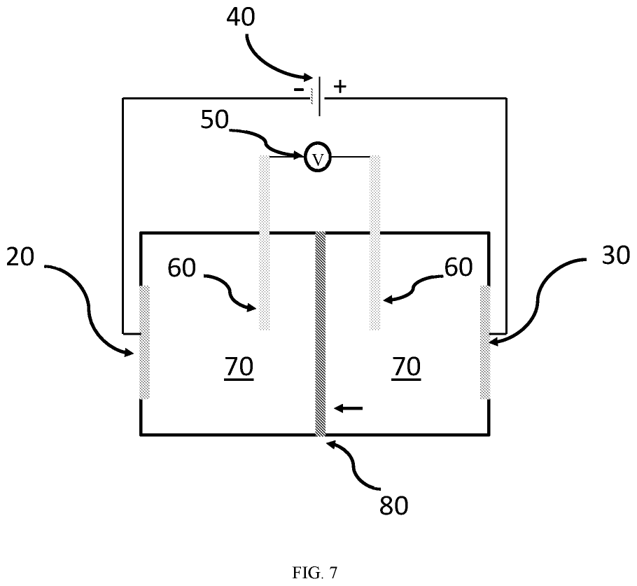

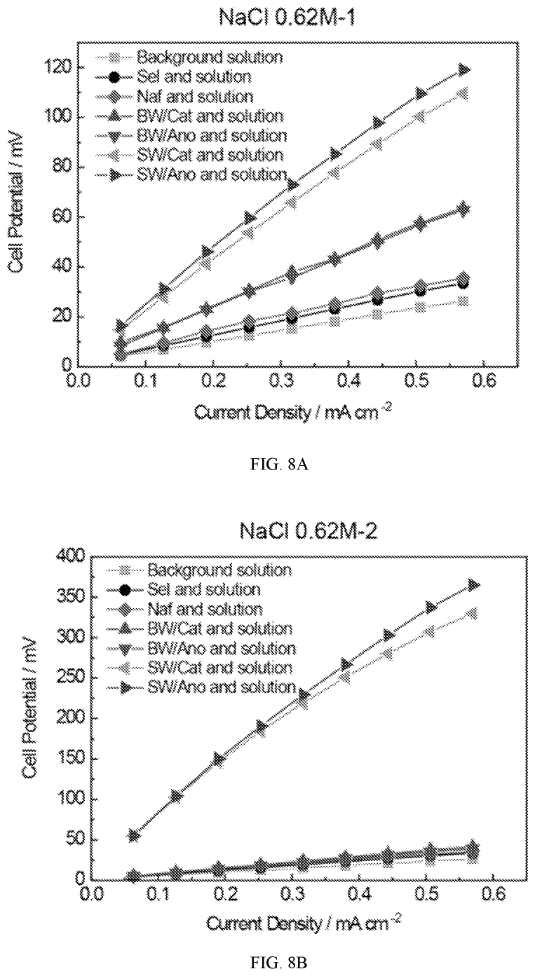

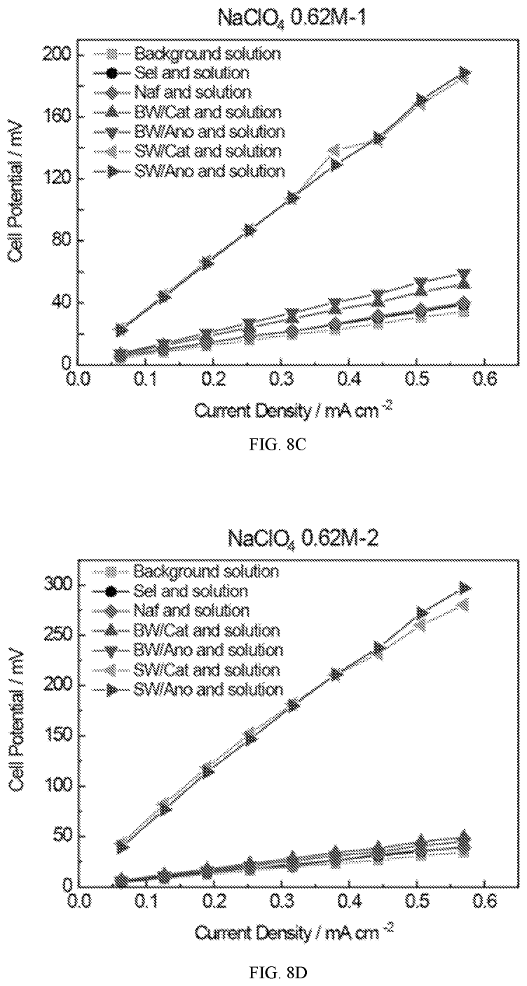

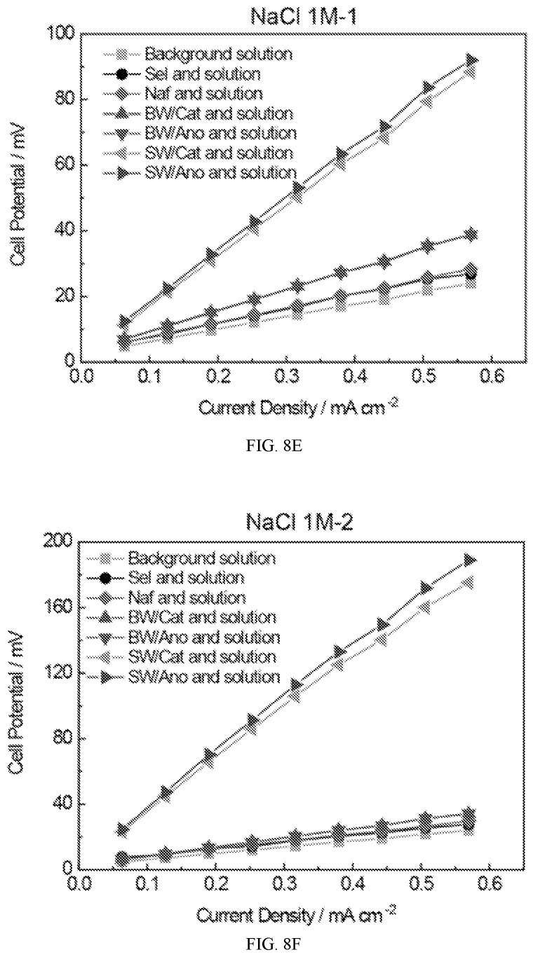

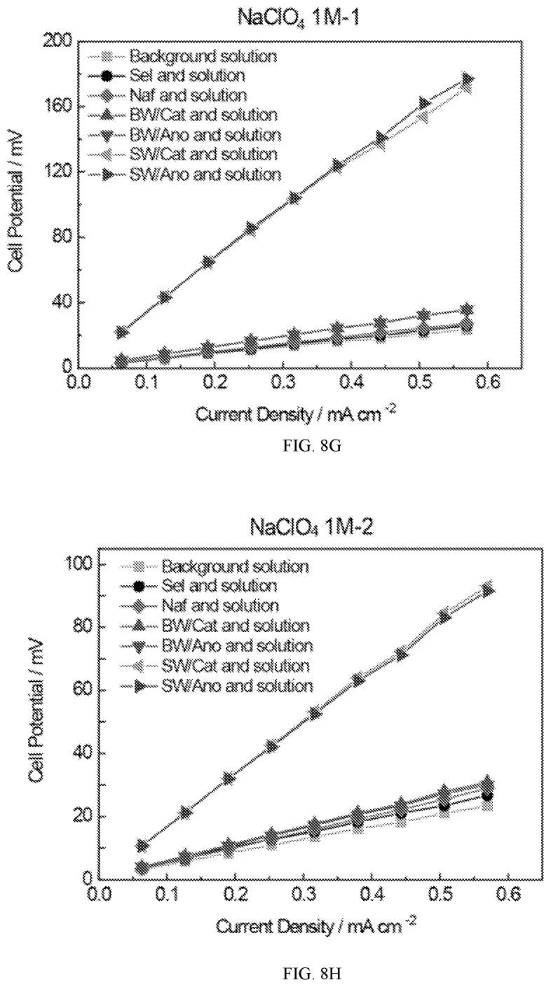

Electrical current generation in conventional water electrolyzers proceeds by the low resistance of the separator or membrane to ion flow, and thus it is critical that alternative membranes, such as RO membranes, have low resistances comparable to CEMs. Using a standard four-electrode approach to measure membrane resistances, it was identified that certain RO membranes exhibit sufficiently low ionic resistances in highly saline solutions (FIG. 7). For example, tests using a standard, unmodified brackish water thin film RO membrane (BW), with the active layer facing the cathode (BW/Cat) exhibited a resistance of 21.7±3.5 Ωcm² at low current densities (<1 mA cm⁻²) in a 1 M NaCl electrolyte and 16.8±4.8 Ωcm² in a 1 M NaClO₄ electrolyte (FIG. 1A, FIGS. 8A-8H). These resistances were reasonably low but somewhat larger than those measured for the Selemion CEM (Sel) of 4.2±1.2 Ωcm² and Nafion 117 (Naf) of 7.2±0.8 Ωcm², and a resistance reported (4.891 cm², Sel) under the same conditions of 1 M NaCl (G. M. Geise, et al., Environ. Sci. Technol. Lett., 2014, 1, 36-39). These relatively low RO membrane resistances were not found to be an intrinsic property of all RO membranes. For example, another RO membrane (SW, DuPont Co) had a much larger resistance of 190±75 Ωcm² in 1 M NaCl electrolyte and 190±65 Ωcm² in 1 M NaClO₄ electrolyte with the active layer facing the cathode (SW/Cat). As discussed herein, the low resistances measured here for the BW RO membrane at a low current density (<1 mA cm⁻²) relative to those desirable for water electrolyzers would not enable the production of large proton gradients on the membrane surface that can be important in maintaining ion balances at higher current densities.

Membrane resistances depended more on the membrane used rather than the orientation of the active layer or the specific electrolyte. Resistances measured using a 1 M NaClO₄ electrolyte were similar to those obtained using a 1 M NaCl electrolyte for both RO membranes, independent of membrane orientation (FIG. 1A). Lowering the electrolyte concentration to that of seawater (0.62 M NaCl) increased the measured resistances for all membranes (FIG. 1B, FIGS. 8A-8H). The resistances were 13.5±0.3 Ωcm² for Sel, 46±18 Ω cm² for BW/Cat, and 310±170 Ωcm² for SW/Cat in 0.62 M NaCl electrolyte. The lower ionic resistance of BW membranes suggests this membrane is more permeable to ion transport than the SW membrane, which is further examined below.

Cell Performance with RO Membranes

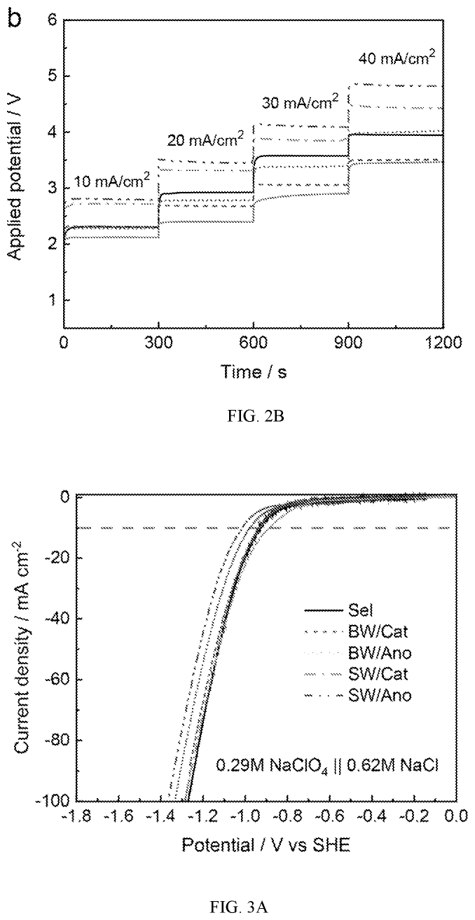

The overall energy requirements for water electrolysis is a function of the applied voltage, which depends on the cell current, membrane resistances, solution resistances and electrode overpotentials. A linear sweep voltammetry (LSV) of a model electrolysis cell with all four membranes showed that the Naf membrane produced the highest current densities at a given potential, with the BW/Cat producing the next highest current densities at an applied potential of 3.5 V (FIG. 2A). At a current density of 10 mA cm⁻² commonly used to compare overpotentials, similar potentials were required for all cases except for the SW/Cat and SW/Ano conditions. There were larger differences between the BW and SW membranes than those due to the orientation of the active layers (FIG. 2A). In chronoamperometry (CP) tests at current density of 40 mA cm⁻², the required potentials were lowest for the BW/Cat membrane and the Naf compared to the other membranes and test conditions (FIG. 2B). Differences in measured potentials were primarily due to differences in mass transfer resistances for each ion species, presumably through the membrane, as the same electrode materials (10% Pt/C electrodes) and electrolytes (1 M NaClO₄ anolyte and 1 M NaCl catholyte) were used in these tests.

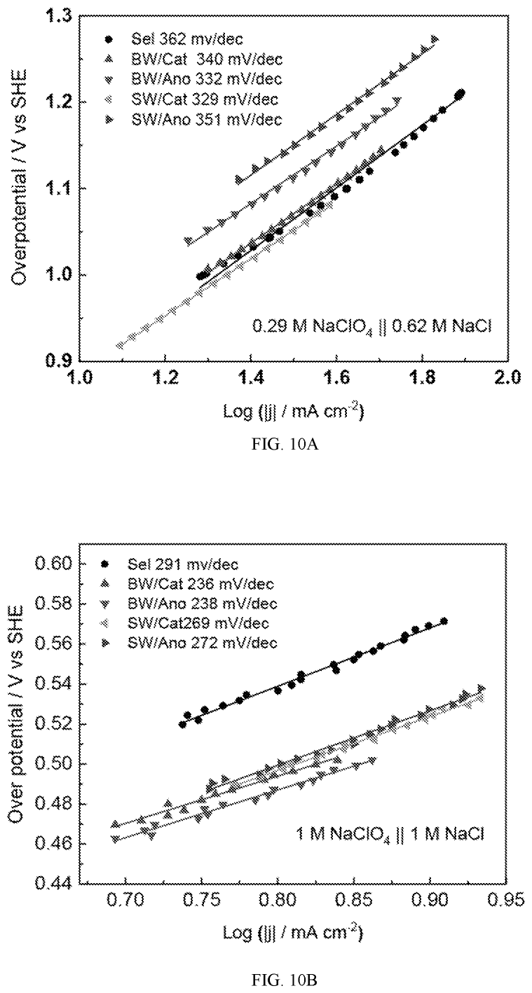

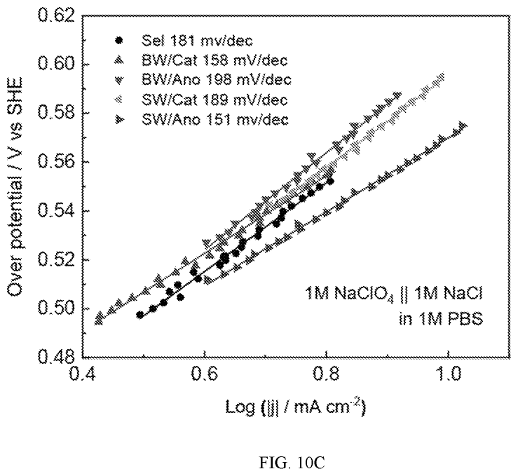

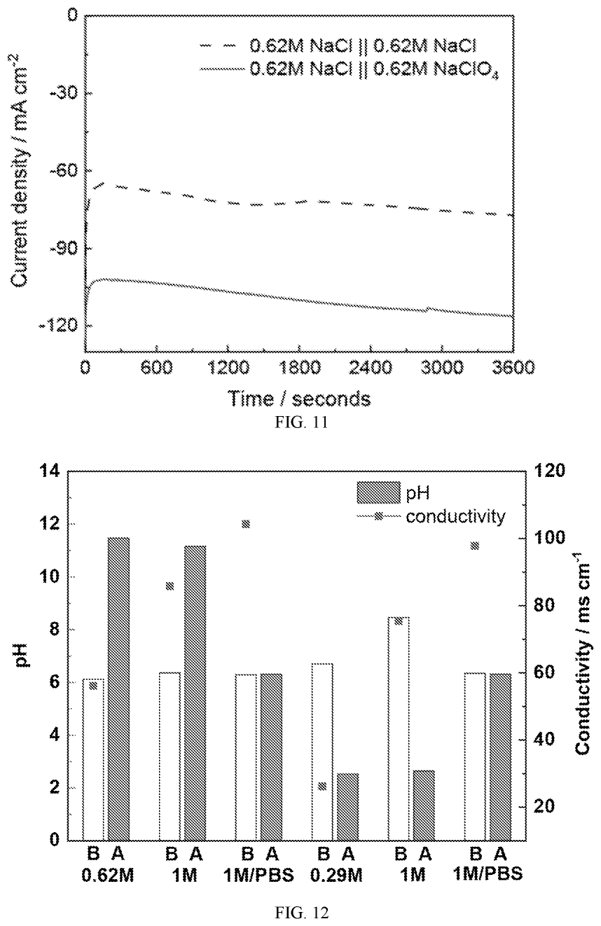

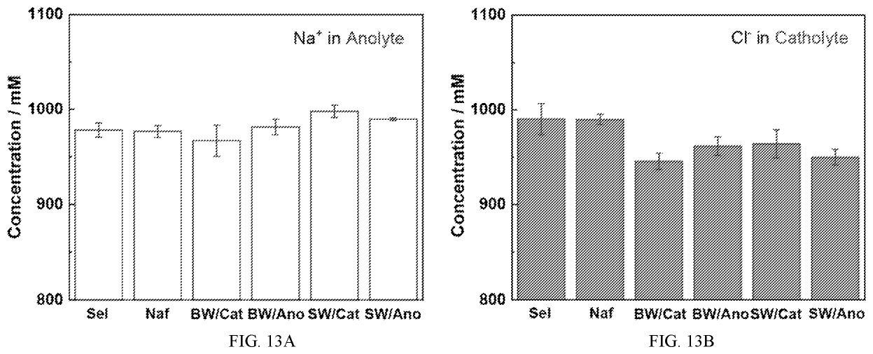

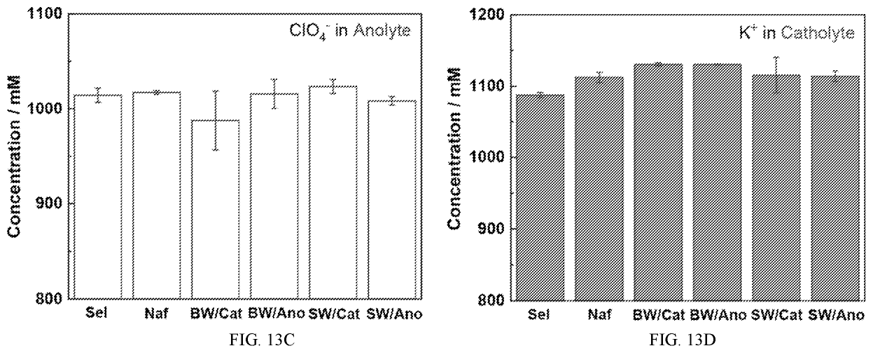

The choice of using RO membranes or ion exchange membranes will impact the specific ions transported across the membrane, as the RO membrane is selective primarily based on ionic size and mobility, while the CEM will primarily transport cations. Interestingly, these differences did not substantially impact cathode performance based on monitoring the individual electrode reactions. When NaCl was used as the catholyte at a concentration representative of seawater (3.5 wt %, 0.62 M), with the anolyte added at the same mass concentration (3.5 wt %, 0.29 M NaClO₄), the cathode potential was −1.0 V vs. SHE at 10 mA cm⁻² with a Tafel slope of 362 mV/dec for Sel and 340 mV/dec for BW/Cat (FIGS. 10A, 10B, 10C). Using these electrolytes at the same concentration (1 M) decreased the magnitude of applied potential to −0.60 V vs. SHE at 10 mA cm⁻², with a decreased Tafel slope of 291 mV/dec for Sel and 236 mV/dec for BW/Cat. The performance of the cathodes used in this study were impacted by solution conditions (FIG. 12), as shown by a decrease in the Tafel slope to 181 mV/dec for Selemion and 158 mV/dec for BW/Cat membrane by adding a phosphate buffer to the anolyte and catholyte to improve performance. When a Tafel slope is larger than ˜120 mV per decade, overall rates are likely limited by mass transfer rather than electrode kinetics (M. Chatenet, et al., J. Power Sources, 2020, 451, 227635). The use of solutions that could be more applicable for a seawater-based electrolyzer (i.e. 0.62 M NaCl catholyte and NaClO₄ anolyte) rather than more optimal electrolytes (e.g. higher salt concentrations and buffered solutions) would be expected to reduce mass transport limitations. This comparison of the electrode overpotentials and Tafel slopes does, however, show the similarity of RO and CEM membranes when mass-transport was controlling the performance (i.e. Tafel slopes >120 mV/dec). An additional chronoamperometry experiment was conducted using 0.62 M NaCl in both chambers for 1 hour at −1.2 V vs. SHE applied potential (for cathode), producing a current density of 60-90 mA cm⁻² (FIG. 11). In these tests there was clear evidence of damage to the Selemion membrane due to chlorine evolution from Cl⁻ oxidation in the anolyte. In contrast, there was no observable membrane damage under the same conditions using the 0.62 M NaClO₄ anolyte. This experiment provided direct evidence that evolution of reactive, oxidized chlorine species can be avoided by choosing a contained and unreactive anolyte.

Transport of Electrolyte Salts Across Membranes

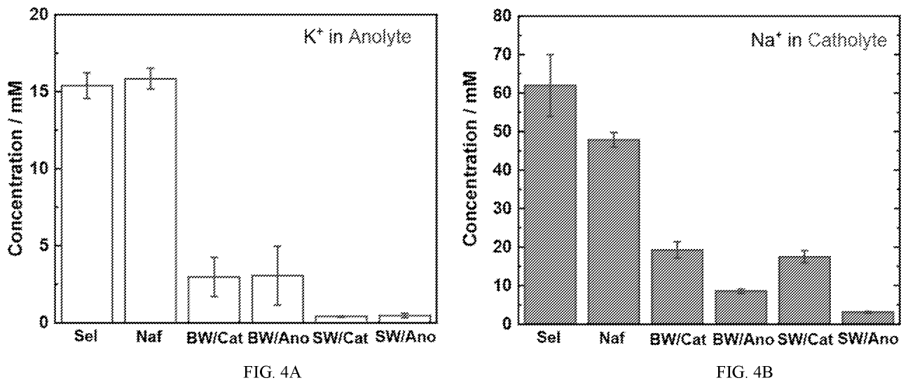

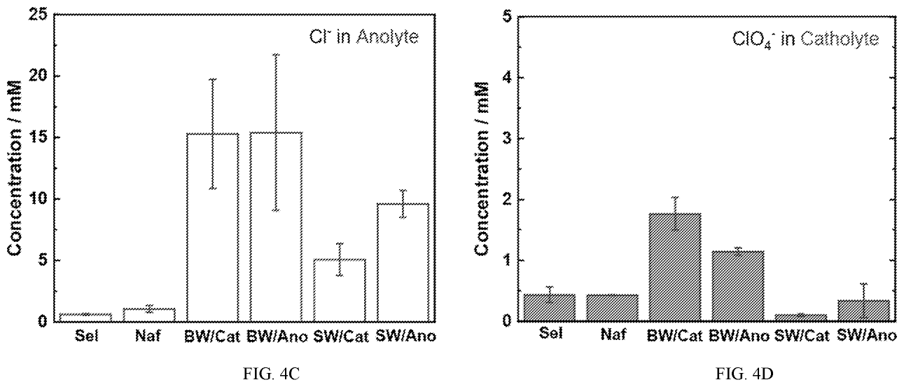

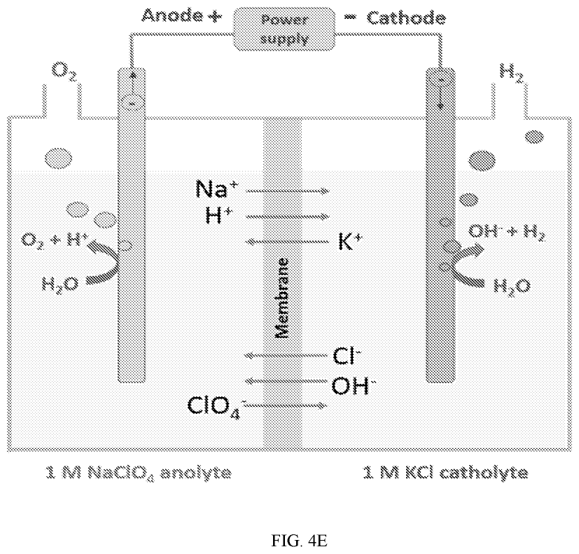

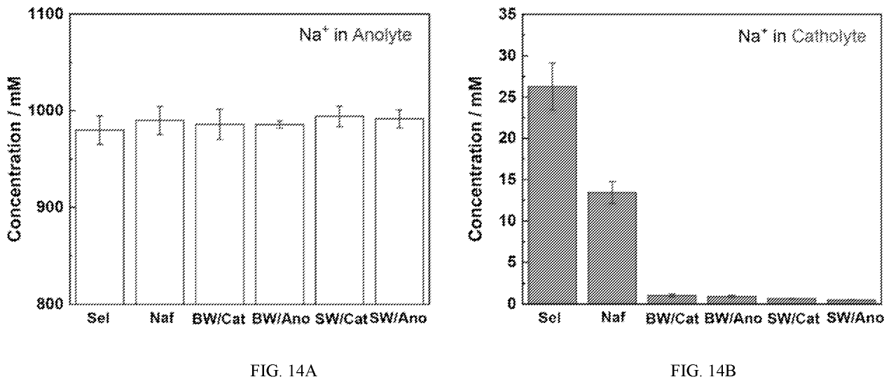

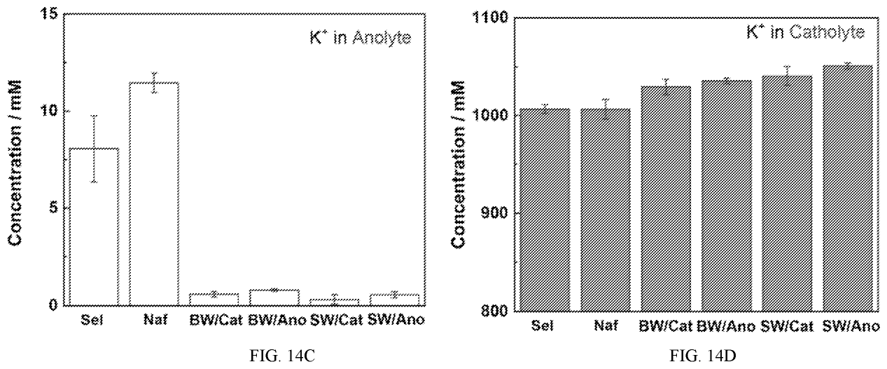

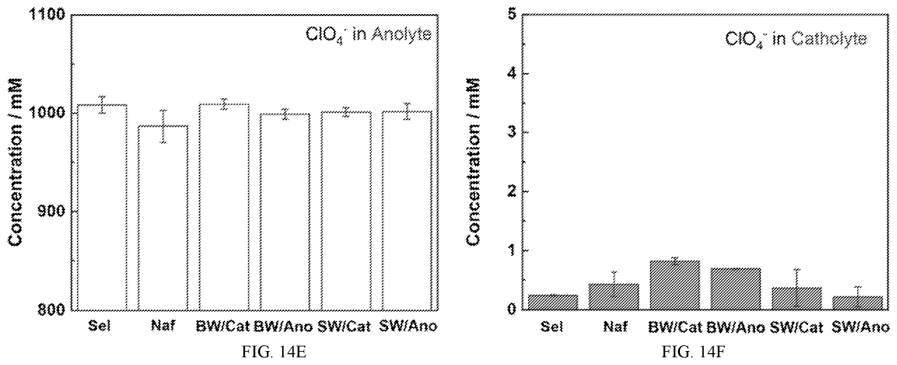

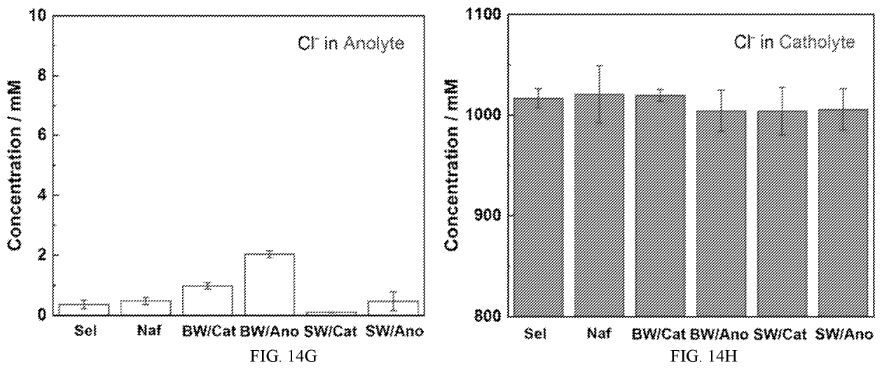

CEMs are designed to facilitate cation transport, but RO membranes selectively transport smaller ions, and therefore transport of larger cations such as Na⁺ could be reduced relative to protons for RO membranes under comparable solution conditions and current densities. RO membranes are not perfectly selective for ion transport, however, and there will be some crossover of larger ions due to membrane pore size variability and defects due to diffusion as a result of the large concentration gradient and the electric field. To examine the extent of cation crossover in the presence and absence of an electrical field, sodium perchlorate in the anolyte and potassium chloride in the catholyte were used (1 M NaClO₄ anolyte and 1 M KCl catholyte) at set current densities of 10 and 40 A m⁻², and compared the concentration of each ion after one hour to the control (no current FIGS. 14A-14H). Na⁺ ions were transported to a greater extent than other ions due to the concentration gradient (no current) for CEMs compared to RO membranes, and total Na⁺ ion transport increased in proportion to the current (FIGS. 4A-4D). With only the concentration difference (no current), the final Na⁺ concentrations in catholyte were higher using CEMs than RO membranes, with 26.3±2.8 mM for Sel and 13.4±1.3 mM for Naf, with Na⁺ concentrations <1.2 mM for the RO membranes (1.02±0.17 mM for BW/Cat and 0.64±0.04 mM for SW/Cat; FIGS. 14A-14H). This same trend of increased Na⁺ transport with CEMs compared to RO membranes was observed with electric field applied. At 40 A m⁻², the transport of Na⁺ in the direction of the electrical field (i.e. towards the cathode) led to 62±8 mM of Na⁺ (Sel) and 48±2 mM (Naf), compared to a lower range of 17.5±1.6 mM (SW/Cat) to 19.3±2.1 mM (BW/Cat) for the RO membranes (FIGS. 4A-4D). These salt concentrations were reduced with a lower current of 10 A m⁻² (42.4±4.8 mM, Sel, 18.5±4.9 mM, Naf, compared to 6.09±0.13 mM, BW/Cat, 5.59±0.35 mM for SW/Cat), indicating enhanced Na⁺ ion transport due to the electrical field. Because ion transport in solution is needed to balance the same applied current, these results indicated that the charge balance was maintained by ions other than Na⁺ to a greater extent in the RO membranes than in the CEMs.

The electrical field only had a small effect on K⁺ ion transport towards against the electric field (towards the anode) with all membranes, indicating most of K⁺ transport was likely due to diffusion not migration. There was still greater K⁺ ion transport with the CEMs (15.4±0.8 and 8.0±1.6 mM, Sel) than the RO membranes (2.9±1.2 and 0.59±0.13 mM, BW/Cat) (FIGS. 4A-4E, 14A-14H, and 15A-15H), both with and without an electric field. Diffusion of K⁺ or Na⁺ into the opposing electrolyte therefore was due to the large concentration gradients between the two chambers, with greater transport against the electric field due to the higher permeability of positively charged cations through the CEMs.

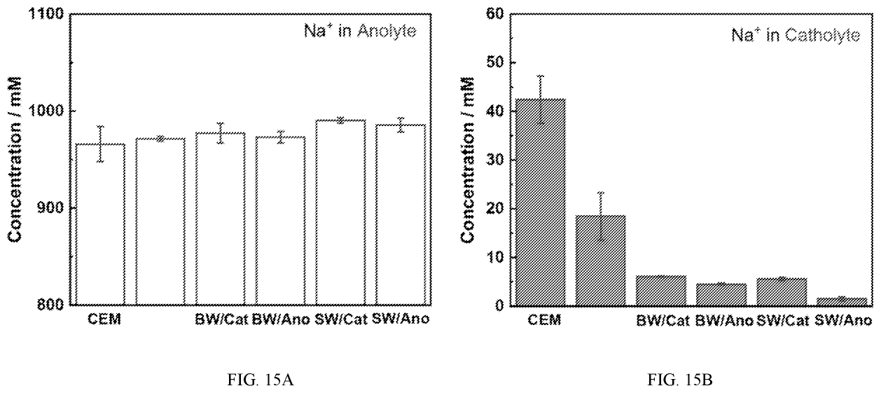

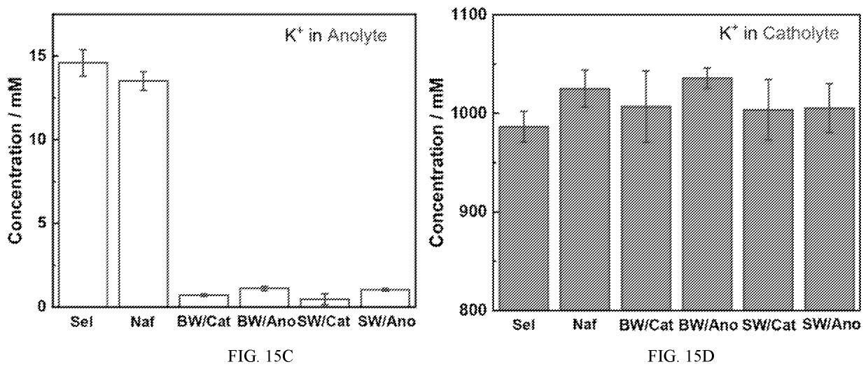

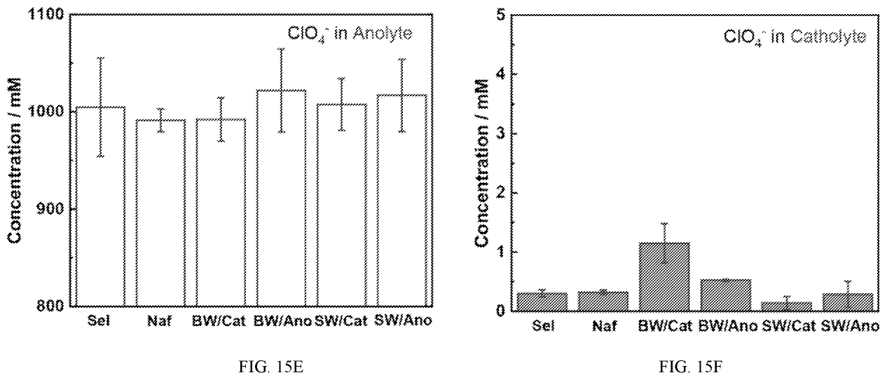

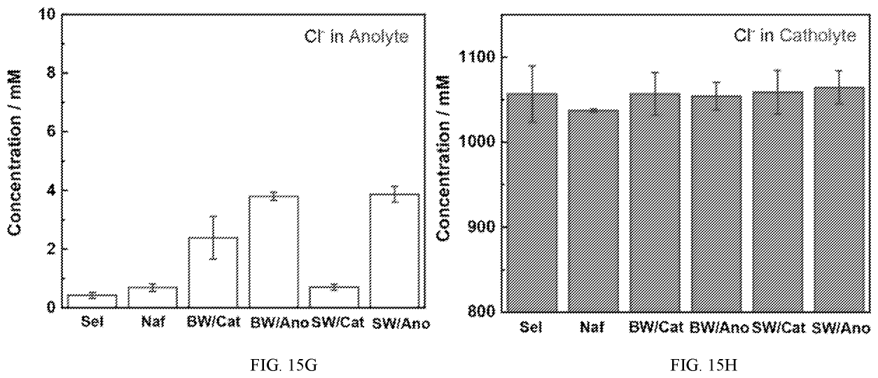

Anion transport was enhanced in the direction of the electric field (towards the anolyte) using RO membranes compared to CEMs which better restrict anion transport. After 1 hour there was 5.1±1.2 mM (SW/Cat) and 15.3±4.4 mM (BW/Cat) of Cl⁻ in the anolyte at 40 mA cm⁻², compared to <0.6 mM for the CEMs in all cases (with or without current). Chloride transport was enhanced by the electric field as there was <1 mM accumulation of Cl⁻ in control experiments with no current (0.10±0.01 mM, SW/Cat; 0.98±0.09 mM, BW/Cat). For ClO⁴⁻, ion transport against the electrical field resulted in a range of 1.76±0.26 mM (BW/Cat) to 0.09±0.02 mM (SW/Cat) in the catholyte for the RO membranes with 40 mA cm⁻². However, in other tests at 10 mA cm⁻² (FIGS. 15A-15H), there was little overall enhanced perchlorate ion transport out of the anolyte indicating its transport through the membrane was mainly by diffusion.

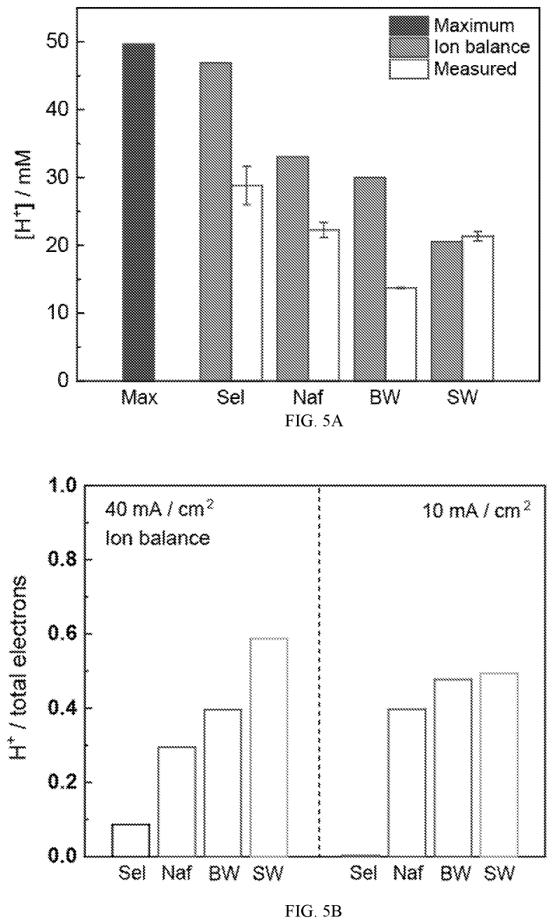

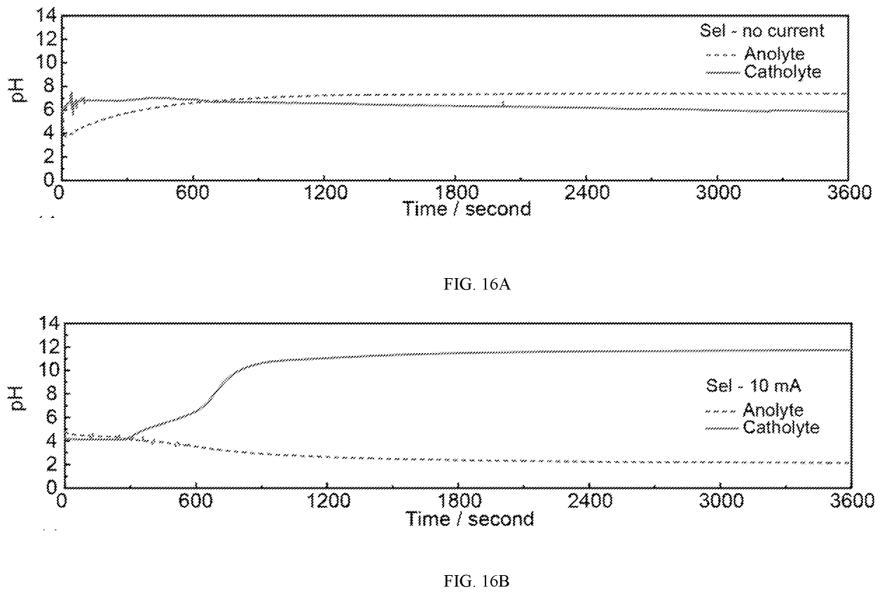

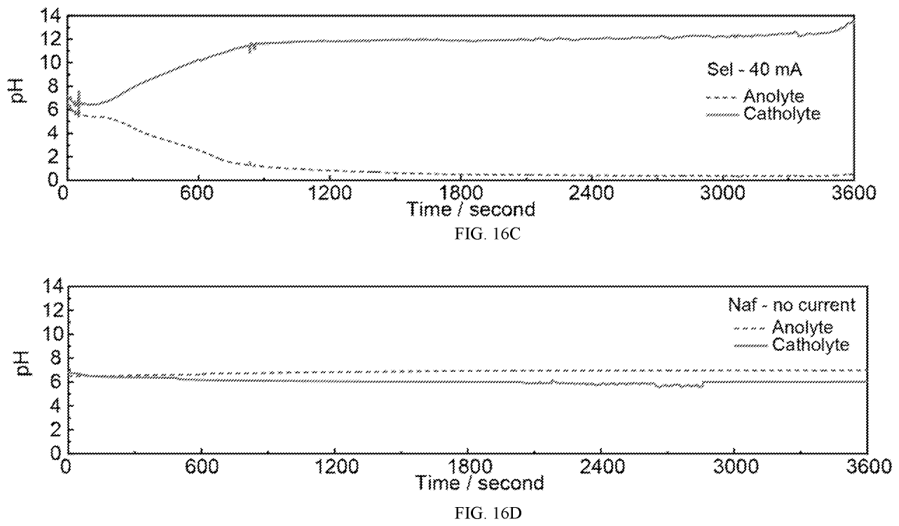

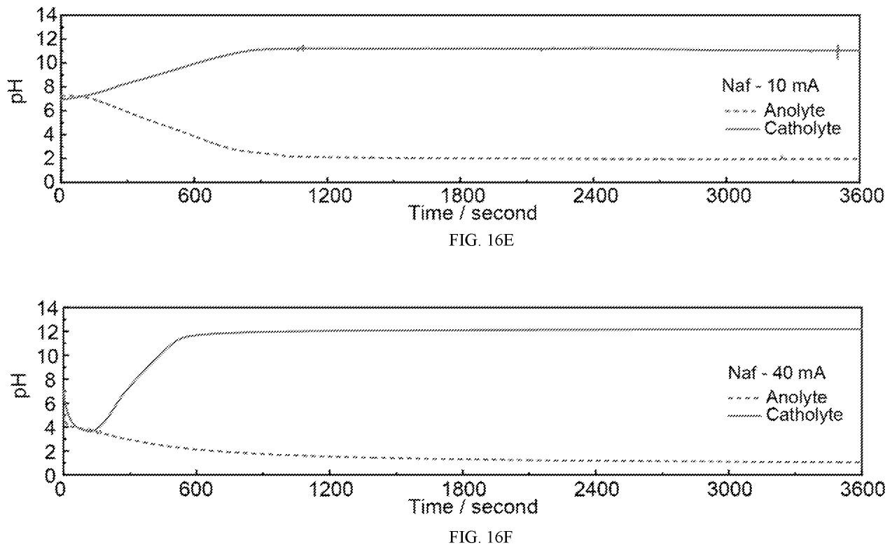

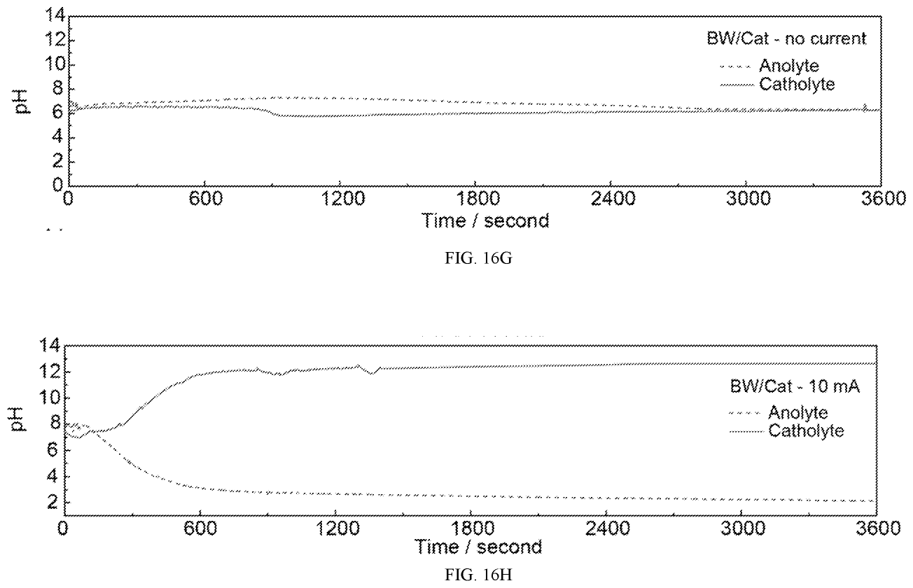

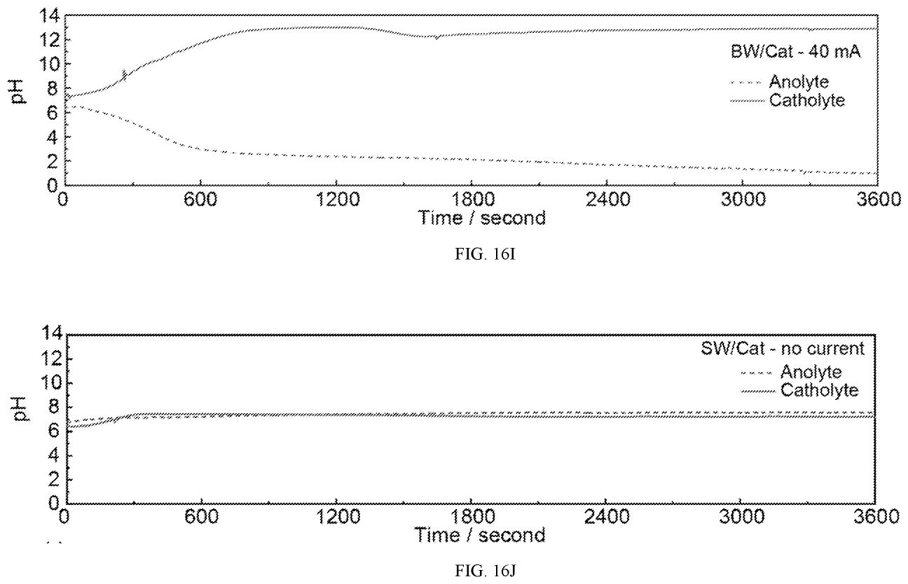

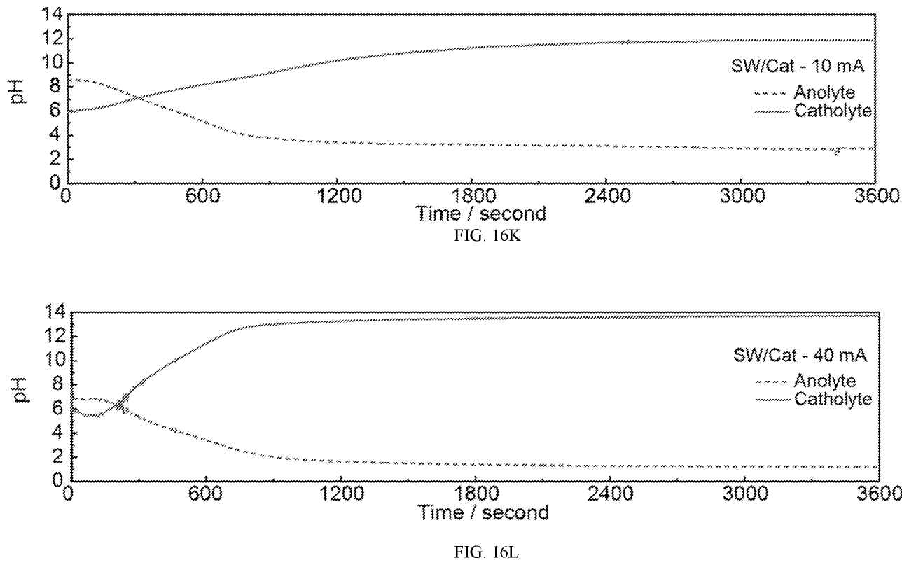

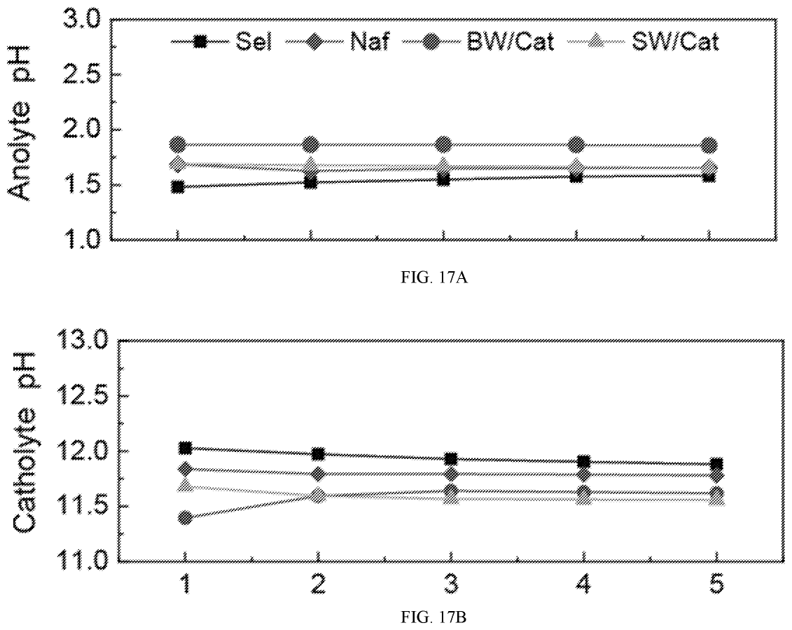

The fraction of charge that was carried through the membrane to maintain charge balance when a current is applied was calculated by performing an ionic charge balance using the data in FIGS. 4A-4D. Proton production in the anode chamber reduces the anolyte pH, and hydroxide production in the catholyte chamber increases the catholyte pH, as observed for both CEM and RO membranes (FIGS. 16A-16L). The maximum proton concentration in the anolyte was calculated assuming that 100% of the current led to proton production with a 1H+:1e− ratio, and that no protons were transported through the membrane (Max, FIG. 5B). Based on the set current (40 mA cm⁻²) the maximum possible proton concentration was 49.7 mM in anolyte. The calculated value was generated by performing a charge balance calculation (Ion balance, FIG. 5A), and the measured concentrations were obtained using a pH electrode of the final electrolyte (Measured, FIG. 5A). The calculated proton concentrations remaining in the anolyte were higher than those measured, indicating additional ion transport occurred between the electrolyte chambers either due to ion swapping reactions or membrane imperfections. The measured remaining proton concentrations in the anolyte for all membranes, converted from the measured pH values of final anolytes (FIGS. 17A and 17B), were much lower than this maximum, with 27.9 mM for Sel, 22.2 mM for Naf, 13.7 for BW/Cat and 20.0 mM for SW/Cat, supporting the passage of protons through both CEMs and RO membranes due to the imposed electrical field (FIG. 5A).

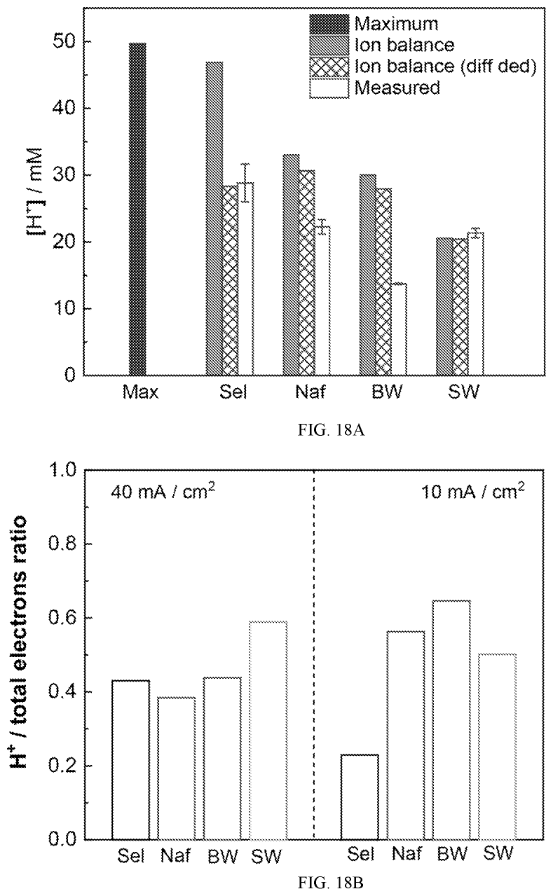

Based on these experiments and additional tests conducted under a lower applied current density (10 mA cm), it was concluded that the selectivity of proton transport is larger for the RO membranes than for the CEMs (FIG. 5B and FIGS. 18A and 18B). For example, 0.08 mmol of protons were transferred through the Sel membrane, or 5% of the total charge (1.49 mmol) needed to balance charge at 40 mA cm⁻². For the RO membranes 0.6 mmol or 40% of the total charge was protons for the BW/Cat configuration, and 0.88 mmol or 59% for SW/Cat configuration at 40 mA cm⁻² (details of the calculation are provided below).

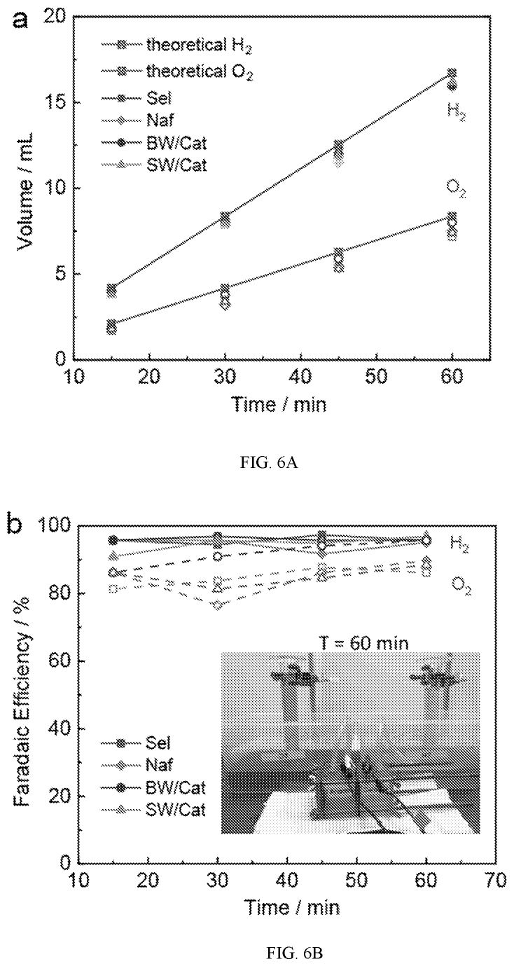

A water displacement gas collection system was used to collect the gases produced by the cathode and anode to evaluate gas recoveries for practical applications and Faradaic efficiencies (FIGS. 6A and 6B). Gas collection tests were conducted using a 1 M NaCl catholyte and 1 M NaClO₄ anolyte. At a set current density of 40 mA cm⁻² for 1 hour, H₂ and O₂ were produced at the expected molar ratio (2.13±0.09:1) (FIG. 6A). A total of 16.0±0.2 mL H₂ was obtained within 1 hour, showing a Faradaic efficiency of >95% in all tests with the different membranes. The smaller Faradaic efficiency for O₂ evolution could have been due to carbon corrosion of the anode which was not optimized for these membrane-based tests (FIG. 6B).

Engineering RO membranes to function more efficiently in salty water electrolyzers.

There is a well-known tradeoff in RO membranes relative to selectivity versus permeability for water flux, but this relationship is not well established in the absence of water transport through the membrane. CEMs achieve selective charge transport of cations over anions, but RO membranes have the advantage of size exclusion to aid transport of protons compared to larger cations. Thus, it was shown that more Na⁺ and K⁺ cations were transferred by CEMs in the presence or absence of current compared to RO membranes (FIGS. 4A-4E). Furthermore, an ion balance demonstrated greater proportion of protons transported through the RO membranes to balance charge than the other ions (FIGS. 5A and 5B). Greater selective transport of protons in RO membranes could be achieved through two approaches: reducing defects and adjusting the charge of the membrane surface.

The surface charge of RO membranes can be varied. The BW membrane used here has been reported to have a more positive surface charge of the active layer at lower pHs and a more negative surface charge of the active layer at higher pHs than the SW membrane (K. Kezia, et al., J. Mem. Sci., 2014, 459, 197-206; E. Idil Mouhoumed, et al., J. Mem. Sci., 2014, 461, 130-138). The negative surface charge is believed to be favorable for protons transport, consistent with results presented herein (FIGS. 2A and 2B). When the active layer of the RO membrane faced the catholyte that had a higher pH (BW/Cat and SW/Cat), the overpotential was lower than that obtained with the active layer facing the anolyte which had a lower pH (BW/Ano and SW/Ano). RO membrane coatings, such as polyethylene glycol, polyvinyl acetate, polydopamine, and other strategies have been used to accomplish surface charge engineering of RO and FO membranes (G. Hurwitz, et al., J. Mem. Sci., 2010, 349, 349-357). The BW membrane is also known to have a higher water flux for a given applied pressure due to less polyamide cross-linking than the SW membrane, which could account for greater diffusional transport of all ions using the BW membrane. The thickness and composition of the structural layer can also impact performance, especially for ionic resistance, with FO membranes designed to have much thinner structural layers to reduce the reverse solute flux from the draw into the feed solution.

Removal of perchlorate through biological treatment is accomplished as described in B. E. Logan, et al., Water Res., 2001, 35, 3034-3038; S. G. Lehman, et al., Water Res., 2008, 42, 969-976; S. Sevda, et al., Bioresour. Technol., 2018, 255, 331-339; P. B. Hatzinger, Environ. Sci. Technol., 2005, 39, 239A-247A. Amending the solution with a substrate such as acetate or even dissolved hydrogen can enable the rapid reduction of perchlorate to chloride in several different types of systems including packed beds, fluidized beds, and hollow fiber membrane bioreactors (S. G. Lehman, et al., Water Res., 2008, 42, 969-976; J. C. Brown, et al., Journal—AWWA, 2005, 97, 70-81; B. E. Logan et al., Water Res., 2002, 36, 3647-3653; R. Nerenberg, et al., Journal American Water Works Association, 2002, 94, 103-114; B. Min, et al., Water Res., 2004, 38, 47-60; H. Zhang, et al., Environ. Microbiol., 2002, 4, 570-576).

The use of RO or FO membranes in water electrolyzers according to aspects of the present disclosure have additional benefits. For example, according to aspects of the present disclosure they are used to directly provide water into the anolyte chamber to replenish that lost during water electrolysis. A current density of 100 mA cm⁻² requires a water flux of 0.34 L m⁻² h⁻¹ (LMH). By altering the anolyte concentration to act as a draw solution, or through adjusting pressure in the two chambers, it is possible to add additional water source into the anolyte chamber. Adding water is optionally conducted in the absence of current generation to avoid carryover of dissolved H₂ into the anode chamber. The RO membrane can avoid gas phase transfer between the chambers, which is used in CEM water electrolyzers to enable higher pressure hydrogen gas production, but not in alkaline water electrolyzers that usually use a separator which is more permeable to gas transport.

While the main focus of the studies here is to enable the direct use of seawater in these systems, the ion transport properties of the RO membranes their use in conventional water electrolyzer systems based on the use of low conductivity or alkaline solutions is explicitly contemplated and encompassed by the present disclosure.

Materials and Methods

The electrodes used for electrochemical measurements were carbon-based electrodes with a supported platinum catalyst (ETEK 10 wt % Pt on Vulcan XC-72, 0.35 mg cm⁻²). Electrolytes consisted of 0.29 M, 0.62 M or 1 M solution of the salt (NaCl, NaClO₄ or KCl) in deionized water (DI, >18 MΩ cm at room temperature). Buffered electrolytes were prepared by dissolving NaCl or NaClO₄ in 1 M phosphate buffer (1 M PBS, pH 7). All chemicals were used as received from Sigma-Aldrich. The membranes used were two cation exchange membranes Selemion CMV (Sel; Asahi Glass, Japan), and Nafion 117 (Naf; Chemours) and two polyamide-based thin-film composite membranes (TFC) for seawater (SW; SW 30HR, DuPont) or brackish water (BW; BW 30LE, DuPont) reverse osmosis (RO). Different active layer orientations of the BW and SW membranes were used to compare their performance. When the active layer faced the cathode, the membranes are designated as BW/Cat and SW/Cat, and when they face the anode as BW/Ano and SW/Ano. The thickness of Selemion CMV was 98±1 μm with an ion exchange capacity of 2.08 meq g⁻¹. The thickness of Nafion 117 was 183 μm with an ion exchange capacity of 0.88 meq g⁻¹. The thicknesses of the RO membranes were 123±5 μm (BW) and 130±4 μm (SW). These properties of these membranes were based on reports by the manufacturer. All membranes were soaked in DI water for at least 2 days in a refrigerator at 4° C. without other treatments before use.

Membrane Resistance Measurement

The ionic resistances of the different membranes were measured using a standard four-electrode method at room temperature as described in Geise, et al., Environmental Science & Technology Letters 1, 36-39, doi:10.1021/ez4000719 (2014). All membranes were first immersed in salt solution for 1 day to be equilibrated with the solutions before measurements. The membrane was placed in the middle of cubic shaped cell containing two separate cylindrical chambers. Each chamber filled with 30 mL of a salt solution (NaCl or NaClO⁴, 0.62 M or 1 M). The membrane area exposed in the aqueous solution was the same as the chamber cross-section (7 cm²). Platinum coated titanium mesh electrodes (4.4 cm²) were placed at each end of the cubic cell (10 cm apart). Current was applied across the cell between two electrodes using a potentiostat (VMP3, Bio-Logic). Two Ag/AgCl reference electrodes (BASi RE-5B, West Lafayette, Ind.) were located directly adjacent to the membrane (1 cm), on each side of the membrane, in order to record the electric potential difference as a function of current density (over a range of 0.06 to 0.6 mA cm⁻², normalized by membrane area) using a digital multimeter. The resistance of the membrane, RM, was determined as follows:

R_{M}=Rₘ₊ₛₒₗ−Rₛₒₗ

where Rₘ₊ₛₒₗ is the resistance of the electrolyte solution measured with the membrane, and Rₛₒₗ is the resistance measured for the electrolyte solution without a membrane. The resistances were determined from the slopes of I-V curves.

Electrochemical Measurements

Hydrogen evolution reaction (HER) studies were carried out in a three-electrode system using a potentiostat (VMP3, Bio-Logic) at room temperature. The cells contained a 10% Pt coated carbon paper (10% Pt/C) as the working electrode, a graphite rod counter electrode, and an Ag/AgCl (3M NaCl) reference electrode. The experimentally applied potential vs. Ag/AgCl potentials were converted to SHE using the following equation:

E_{SHE}=E_{Ag/AgCl-}0.197 V

Linear sweep voltammetry (LSV) was carried out at 5 mV s⁻¹ between 0 V and −1.4 V (vs. SHE) for the polarization curves. All polarization curves were not iR-compensated. Chronoamperometry (CP) tests were conducted at −1.2V (vs. SHE) for 1 hour. The electrolytes were saturated with N₂ purging for 30 min before each test. The volume of each electrolyte was 30 mL in each chamber.

Water electrolysis tests were conducted in a two-electrode system using two identical 10% Pt/C electrodes (1 cm²) in the same cubic shaped cell with two separate cylindrical chambers. The anode and cathode were separated by the indicated type of membrane. All the current densities for electrolyzer cell performance were normalized by the electrode area (1 cm²) unless otherwise specified according to procedures described in Bai, C. et al., Journal of Materials Chemistry A 5, 9533-9536, doi:10.1039/C7TA01708A (2017); and Lai, J. et al., Energy & Environmental Science 9, 1210-1214, doi:10.1039/C5EE02996A (2016)).

Salt Crossover Measurements

In order to monitor the cations and anions crossover the different membranes under the same conditions, 1 M of KCl was used as the catholyte and 1 M NaClO₄ was used as the anolyte. The two-electrode system was used to apply constant current density (10 mA cm⁻² or 40 mA cm⁻²) between anode and cathode for 1 hour. The catholyte and anolyte solutions were collected and diluted 50 times to measure salt ion concentrations using ion chromatography (IC, Dionex ICS-1100, Thermo Scientific). Control experiments were conducted under the same conditions but without any applied current. All the measurements were conducted at least two times with different pieces of membrane.

pH Vs Time Measurements

During the salt crossover measurements when applying different current density between anode and cathode, the pH change of anolyte and catholyte was monitored simultaneously to observe the change in pH during the electrolysis. The final pH was recorded by collecting and mixing the solution. The pH readings will be a little low due to high Na⁺ concentration in solution. The pH probes (ET042 pH Electrode, eDAQ, Australia) were calibrated before each measurement with standard buffer solutions.

Gas Generation Measurements

The generated H₂ and O₂ gases were collected by a drainage method using a lab-made system, shown in FIG. 6. The two chambers were sealed with epoxy with electrodes exposed area of 1 cm². The two-electrode system was used to apply constant current density of 40 mA cm⁻² for 1 hour, with 1 M NaClO₄ as the anolyte and 1 M NaCl as the catholyte. The gas volume in the cylinder was recorded every 15 min. The Faradaic efficiency was calculated by comparing the amount of collected gas production with theoretical moles of gas using the following equation:

$$FE = \frac{{n}_{{H}_{2}}}{{n}_{CE}}$$

The theoretical moles of H₂ (n_{CE}) that could be recovered based on the measured current with the assumption that all electrons passing through the circuit engage in proton reduction is:

$${n}_{CE} = \frac{{\int }_{i = 1}^{n} {I}_{i} Δ t}{2 F}$$

where, Δt is the internal time over which current data are collected, and F=96485 C mole⁻¹ electron is Faraday's constant. Each mole of H₂ generation requires two moles of electrons.

Charge Balance and Proton Transport Example Calculation

For a current density of 40 mA cm⁻² for 1 hour, if the Faraday efficiency is 100% for both H₂ and O₂, the produced moles of H₂ (n_{CE}) should be:

$${n}_{CE} = \frac{{\int }_{i = 1}^{n} {I}_{i} Δ t}{2 F} = 7.46 \times {10}^{- 4} mol$$

and moles of O₂ (n_{CE}) should be:

$${n}_{CE} = \frac{{\int }_{i = 1}^{n} {I}_{i} Δ t}{4 F} = 3.73 \times {10}^{- 4} mol$$

Therefore, the total water consumption is 7.46×10⁻⁴ mole, and the total volume of water consumption is:

$${V}_{{H}_{2} O} = \frac{( 7.4623 \times {10}^{- 4} mole ) ( 18 \times {10}^{- 3} kg {mol}^{- 1} )}{1 \times {10}^{3} kg {m}^{- 3}} = 1.34 \times {10}^{- 2} mL$$

The water volume change due to electrolysis:

$$Δ {V}_{{H}_{2} O} = \frac{1.34 \times {10}^{- 2} mL}{60 mL} \times 100 \% = 0.0223 \%$$

Therefore, the water volume change due to electrolysis was negligible. The total moles of ions transported through membrane can be calculated based on the average number of each ion from IC results and the solution volume of each chamber (30 mL).

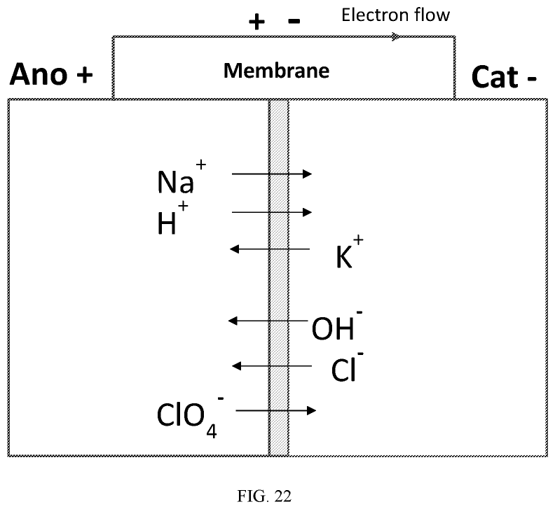

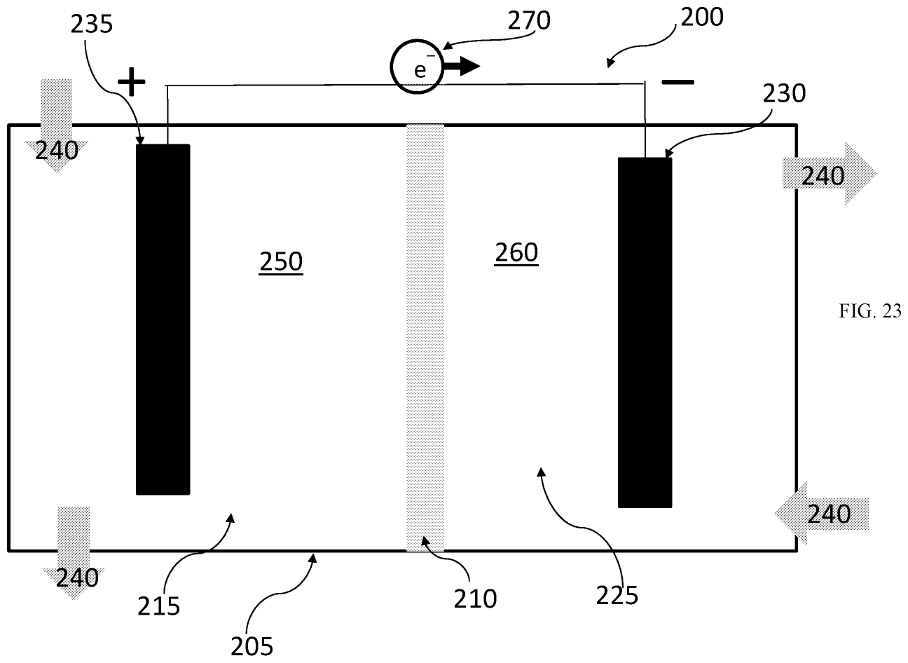

The current density is summed up with contributions from each negative and positive ions species, as illustrated in FIG. 22. The cations moving from anolyte to catholyte and anions moving from catholyte to anolyte are considered as positive (+) to the current. In the opposite, the cations moving from catholyte to anolyte and anions moving from anolyte to catholyte are considered as negative (—) to the current. The H⁺ and OH⁻ transport in the opposite direction is considered in total as the net proton transport.

Selemion CEM and BW/Cat membranes were used as examples for the following calculations, where ion concentrations were averages obtained from multiple IC measurements. For Selemion CEM, the total ions transported through the membrane in the absence of current were:
Moles of Na⁺ in Catholyte: n_{Na}_{⁺}=26.3 mM×30 mL=0.79 mmol of charge equivalents
Moles of K⁺ in Anolyte: n_{K}_{⁺}=8.1 mM×30 mL=0.24 mmol of charge equivalents
Moles of Cl⁻ in Anolyte: n_{Cl}_{^{−}}=0.5 mM×30 mL=0.015 mmol of charge equivalents
Moles of ClO₄⁻ in Catholyte: n_{ClO}_{₄}=0.3 mM×30 mL=0.009 mmol of charge equivalents
   Therefore, the net ion transport is
nᵢₒₙ=0.79-0.24+0.015-0.009=0.56 mmol of charge equivalents

For a current density of 40 mA cm⁻², the total ions transport through the Selemion CEM membrane was:
Moles of Na⁺ in Catholyte: N_{Na}_{⁺}=62.0 mM×30 mL=1.86 mmol of charge equivalents
Moles of K⁺ in Anolyte: n_{K}_{⁺}=15.4 mM×30 mL=0.462 mmol of charge equivalents
Moles of Cl⁻ in Anolyte: n_{Cl}_{^{−}}=0.6 mM×30 mL=0.018 mmol of charge equivalents Moles of ClO₄⁻ ″ in Catholyte:n_{ClO}_{₄}_{^{−}}=0.4 mM×30 mL=0.012 mmol of charge equivalents
   Therefore, the net ions transport is:
nᵢₒₙ=1.86-0.462+0.018-0.012=1.41 mmol of charge equivalents

The net ions that contributed to current without deducting ion transport by diffusion is:
nᵢ=1.41 mmol of charge equivalents

The net ions contribute to current after deducting the ion transport due to diffusion is:
nᵢ′=1.41-0.56=0.85 mmol of charge equivalents

Similarly, for BW/Cat, the total ions transport through membrane under no current condition:
Moles of Na⁺ in Catholyte: n_{Na}_{⁺}=1.0 mM×30 mL=0.03 mmol of charge equivalents
Moles of K⁺ in Anolyte: n_{K}_{⁺}=0.6 mM×30 mL=0.02 mmol of charge equivalents
Moles of Cl⁻ in Anolyte: n_{Cl}_{^{−}}=0.98 mM×30 mL=0.03 mmol of charge equivalents
Moles of ClO₄⁻ in Catholyte: n_{ClO}_{₄}_{^{−}}=0.81 mM×30 mL=0.02 mmol of charge equivalents
   Therefore, the net ion transport is
nᵢₒₙ=0.03-0.02+0.03-0.02=0.02 mmol of charge equivalents

Under the current density of 40 mA cm⁻², the total ions transport through BW/Cat membrane:
Moles of Na⁺ in Catholyte: n_{Na}_{⁺}=19.3 mM×30 mL=0.6 mmol of charge equivalents
Moles of K⁺ in Anolyte: n_{K}_{⁺}=2.9 mM×30 mL=0.09 mmol of charge equivalents
Moles of Cl⁻ in Anolyte: n_{Cl}_{^{−}}=15.3 mM×30 mL=0.46 mmol of charge equivalents
Moles of ClO₄⁻ in Catholyte: n_{ClO}_{₄}_{^{−}}=1.8 mM×30 mL=0.05 mmol of charge equivalents
   Therefore, the net ion transport is
nᵢₒₙ=0.6-0.09+0.46-0.05=0.9 mmol of charge equivalents
   The net ions contribute to current is
nᵢ=0.9 mmol of charge equivalents
   The net ions contribute to current by deducting the ions diffusion is
nᵢ′=0.9-0.02=0.88 mmol of charge equivalents
   Total charges needed to carry 40 mA cm⁻² current density for 1 h is:

$$Q = I t = 40 \frac{mA}{{cm}^{2}} 3600 s = 144 C {cm}^{- 2}$$

Total moles of net electron transfer is:

$${n}_{t} = \frac{144 \frac{C}{{cm}^{2}} 1 {cm}^{2}}{96485 \frac{C}{mole}} = 1.49 m mol of charge equivalents$$

Therefore, the net proton transport to carry current for Selemion CEM is:
n_{H}_{⁺}=1.49 mmol-1.41 mmol=0.08 mmole

After diffusion ions reduction:
n_{H}_{⁺}′=1.49 mmole-0.85 mmol=0.64 mmole
   The net proton transport to carry current for BW/Cat is:
n_{H}_{⁺}=1.49 mmole-0.9 mmol=0.6 mmole

After diffusion ions reduction:
n_{H}_{⁺}′=1.49 mmole-0.88 mmol=0.61 mmole

Considering the diffusion process is affected when applying the electric field, it is difficult to differentiate the portion of ion transport from diffusion versus that due to the electric field. Therefore, the moles of proton transport through Selemion CEM is in the range of 0.08˜0.64 mmol and the moles of proton transport through BW/Cat is in the range of 0.59˜0.61 mmol.

If all the protons generated at anode stay in the anolyte (with the assumption of 100% Faraday efficiency), that means there will be 1.49 mmol of protons in the anolyte after applying 40 mA cm⁻² for 1 hour, so the theoretical pH of the final anolyte should be:

$$pH = - log [ {H}^{+} ] = - log [ \frac{1.49 m mole}{30 ml} ] = - log [ 0.0497 M ] = 1.304$$

Considering the proton transport through the membrane (calculated above), the anolyte pH should be:

### For Selemion CEM:

$$pH = - log [ \frac{1.49 m mole - 0.08 m mol}{30 ml} ] = - log [ 0.0468 M ] = 1.328 = - log [ \frac{1.49 m mole - 0.64 m mol}{30 ml} ] = - log [ 0.0283 M ] = 1.548 diffusion deduction$$

### For BW/Cat:

$$pH = - log [ \frac{1.49 m mole - 0.6 m mol}{30 ml} ] = - log [ 0.0297 M ] = 1.527 = - log [ \frac{1.49 m mole - 0.61 m mol}{30 ml} ] = - log [ 0.0293 M ] = 1.533 diffusion deduction$$

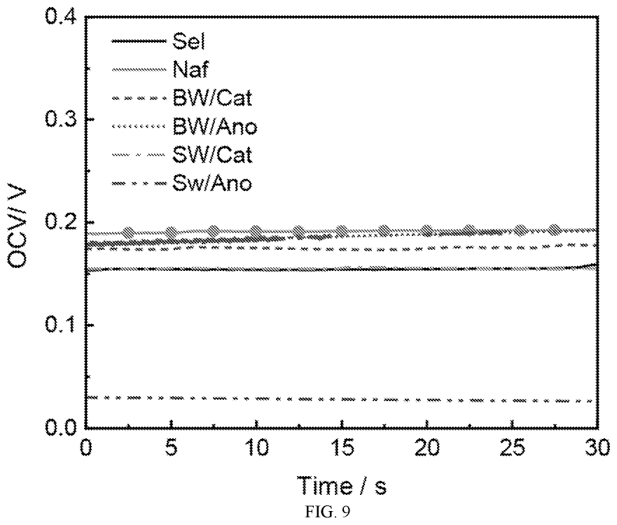

In order to control the LSV, open circuit potential (OCP) of each working electrode was monitored before each test (FIG. 9). The similar OCPs in each test indicated that the over potential for each system could be directly obtained from LSV results without an OCP correction.

During salt crossover tests, the pH was monitored over time using inline pH meter for all the different membranes under each test condition (FIG. 16). However, comparisons of the final pH were not in agreement with the inline measurements suggesting that accuracy of the inline pH measurements were slightly affected by the electrical field when the constant current was applied. Thus, the results in FIG. 16 show a general trend but not the absolute value of the pH. The final pH was measured by collecting the anolyte and catholyte solution to record for 5 min (FIGS. 17A and 17B) to get an average pH, and this pH was used for the ion balance comparison.

A perchlorate salt was used to provide an inert and contained anolyte, with charge balanced by proton and hydroxide ion flow across the RO membrane. Synthetic seawater (NaCl) was used as the catholyte, where it provided continuous hydrogen gas evolution. The RO membrane resistance was 21.7±3.5 Ωcm² in 1 M NaCl and the voltages needed to split water in a model electrolysis cell at current densities of 10-40 mA cm⁻² were comparable to those found when using two commonly used, more expensive ion exchange membranes.

Membrane Stability Over Time

To examine if the transport of ions across the BW membrane was altered over time, chronoamperometry tests were conducted at fixed potential of 3.5 or 4.0 V between the anode and cathode for 10 cycles, with 1 hour for each cycle, using a two-electrode setup. Two pieces of BW membrane were used for duplicate tests. To avoid changes in current that could occur due to degradation of the carbon electrodes both electrodes were replaced with new ones for each cycle. KCl (1 M) was used as the catholyte and NaClO₄ (1 M) was used as the anolyte. At the end of each cycle, both anolytes and catholytes were collected and diluted 50 times for analysis of the concentration of ions.

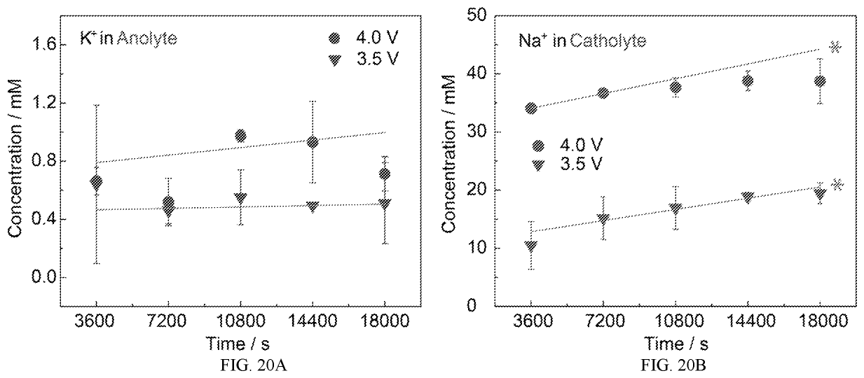

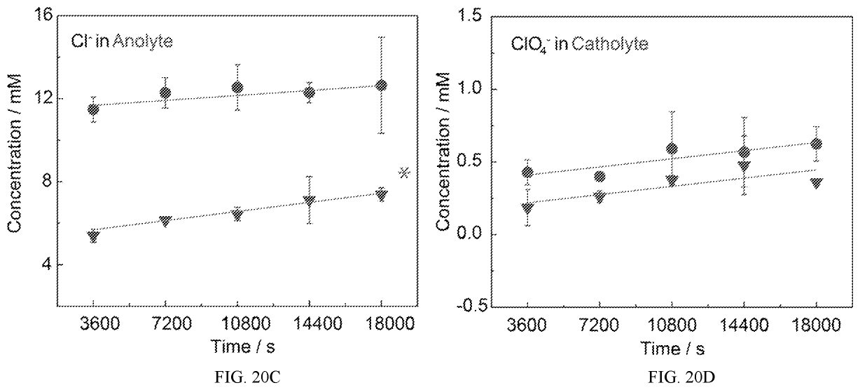

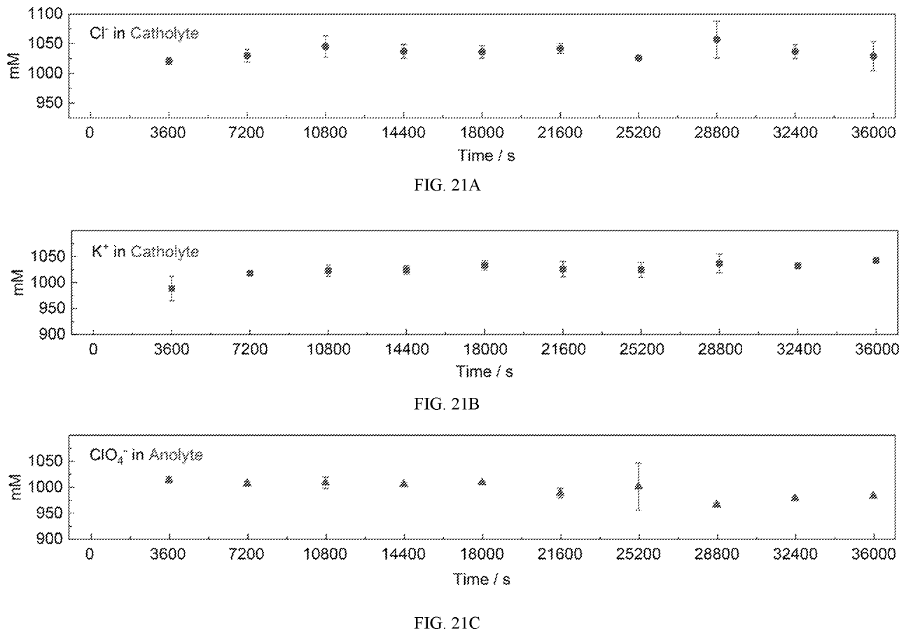

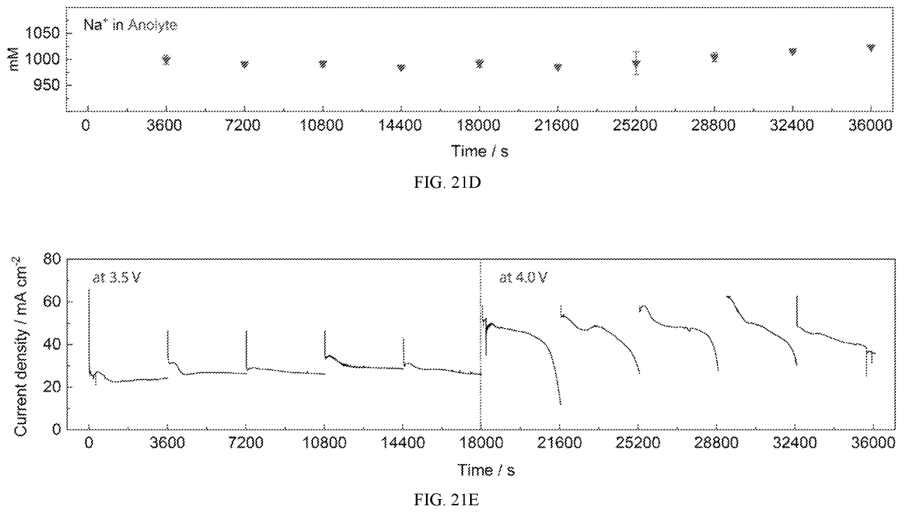

The stability of the BW membrane relative to maintaining a constant current and changes in passage of ions over time was examined by applying a constant potential of 3.5 V for 5 cycles, followed by 5 more cycles with 4.0 V across the anode and the cathode (10 cycles total, each 1 h long). Examination of the changes in total ions transferred showed that ions transported against the electric field (ClO₄⁻ and K+) did not increase in concentration over time based on the lack of significance of the slopes (all with p>0.05) for the final concentrations at the end of each cycle over time (FIGS. 20A-20D), consistent with the results in FIGS. 4A-4D and see additional data in FIGS. 21A-21E. The diffusion of perchlorate and potassium ions was similar in amount over all the data suggesting that the active layer was not impaired during the tests. For the two ions transported in the direction of the electric field (Na⁺ and Cl⁻) the mass of ions transported there was a slight increase in ion transport at 3.5 V (p=0.005) but not at 4.0 V d (p=0.101). For Na⁺ ion transport at both applied voltages there was a small but significant (p=0.027, 3.5 V; p=<0.001, 4.0 V) increase in ion transport over time.

TABLE 1
Table 1: Statistical analysis summary of salt crossover based on final concentrations
after each 1-h cycle. The slopes, R2 and p values are based on the linear regressions
shown in FIG. 20 at different applied potential (3.5 V or 4.0 V).

| | K⁺ in | Na⁺ in | Cl⁻ in | ClO₄⁻ in |
|---|---|---|---|---|
| | Anolyte | Catholyte | Anolyte | Catholyte |
| At 3.5 V | | | | |
| Fitting Slope + | 2.71 × 10⁻⁶ ± | 5.34 × 10⁻⁴ ± | 1.22 × 10⁻⁴ ± | 1.57 × 10⁻⁵ ± |
| SD | 3.48 × 10⁻⁶ | 1.32 × 10⁻⁴ | 1.64 × 10⁻⁵ | 6.84 × 10⁻⁶ |
| R² | 0.16833 | 0.84587 | 0.94874 | 0.63835 |
| P value | 0.49266 | 0.02698 | 0.005 | 0.10488 |
| At 4.0 V | | | | |
| Fitting Slope + | 1.43 × 10⁻⁵ ± | 7.06 × 10⁻⁴ ± | 6.62 × 10⁻⁵ ± | 1.55 × 10⁻⁵ ± |
| SD | 2.26 × 10⁻⁵ | 4.35 × 10⁻⁵ | 2.82 × 10⁻⁵ | 5.01 × 10⁻⁶ |
| R² | 0.11835 | 0.98875 | 0.64664 | 0.76232 |
| P value | 0.57046 | 5.08 × 10⁻⁵ | 0.10094 | 0.5322 |

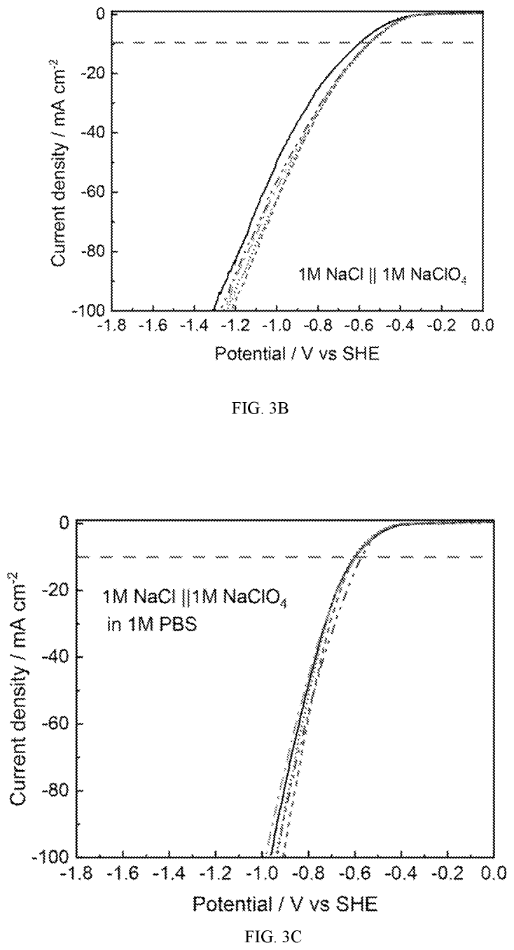

In the examples included herein, performance of two different RO membranes (SW and BW) was examined, in two different configurations (active layers facing in different directions), and a direct comparison of these RO membranes to two different state of the art cation exchange membranes (Nafion used in water electrolyzers and Selemnion as typical CEMs in water treatment) was shown where all membranes were operated under the same conditions. Furthermore, different salt solutions were used to track the transport of different ions across RO membranes or CEMs to provide a direct comparison of performance. For example: FIGS. 1A and 1B show a direct comparison of area-based resistances at a low current density; FIGS. 2A and 2B show direct comparisons of LSVs and CP for the different membranes; FIGS. 3A-3C show direct comparisons in different electrolytes; FIGS. 4A-4E show cross over of ions of CEMs vs RO membranes; and FIGS. 5A and 5B focus on the mechanism showing the importance of proton transport.

Regarding performance, FIGS. 6A and 6B show the hydrogen production by comparisons of volume of hydrogen production and the Faradaic efficiencies.

This is believed to be the first use of an RO or FO membrane (in this example, a polyamide thin film composite membrane) in the field of water electrolysis. It is also believed to be the first demonstration of direct seawater electrolysis using asymmetric electrolytes with a saline solution, brackish water or seawater as catholyte and an inert anolyte such as sodium perchlorate. Furthermore, systems and methods of water hydrolysis demonstrate ion transport in an applied electric field in the absence of an appreciable water flux.

Any patents or publications mentioned in this specification are incorporated herein by reference to the same extent as if each individual publication is specifically and individually indicated to be incorporated by reference.

The compositions and methods described herein are presently representative of preferred embodiments, exemplary, and not intended as limitations on the scope of the invention. Changes therein and other uses will occur to those skilled in the art. Such changes and other uses can be made without departing from the scope of the invention as set forth in the claims.

1. A system for producing hydrogen and oxygen gases by water hydrolysis, the system comprising:
a vessel comprising a first and a second chamber;
a membrane permeable to water ions separating the first chamber and the second chambers, wherein the membrane is effective to substantially exclude passage of salt ions, and wherein the membrane is optionally permeable to water such that the first chamber is in fluid communication with the second chamber;
a cathode in contact with a catholyte in the first chamber,
an anode in contact with an anolyte in the second chamber;
a power source of direct current operably linked to the cathode and the anode;
wherein the anolyte comprises a negative ion inert to oxidation and further wherein the catholyte comprises a saline solution, brackish water, or seawater.

2. The system of claim 1, wherein the anolyte comprises perchlorate.

3. The system of claim 1, wherein the membrane is a reverse osmosis (RO) membrane.

4. The system of claim 3, wherein the membrane is a forward osmosis (FO) membrane.

5. The system of claim 1, wherein the membrane resists passage of gases.

6. The system of claim 1, wherein the catholyte is in fluid connection to a source of further catholyte.

7. The system of claim 1, wherein an applied direct current to the power source establishes an electric potential between the cathode and the anode, the membrane allowing for production of hydrogen gas at the cathode and oxygen gas at the anode.

8. The system of claim 1, wherein the anolyte comprises a higher ionic strength than the catholyte, and wherein the membrane allows water molecules to pass from the catholyte to the anolyte to replace water molecules hydrolyzed due to operation of the system.

9. The system of claim 1, wherein the catholyte is a buffered saline solution.

10. A method of producing hydrogen and oxygen gas by water hydrolysis comprising applying a direct current to the system of claim 1.

11. The method of claim 10, wherein the catholyte is periodically partially or completely refilled.

12. The method of claim 10, wherein the anolyte is periodically partially or completely refilled.

13.-14. (canceled)
